(19) United States
(12) Patent Application Publication
(10) Pub. No.: US 2024/0039601 A1
(43) Pub. Date: Feb. 1, 2024

(54) ITERATIVE PRECODER COMPUTATION AND COORDINATION FOR IMPROVED SIDELINK AND UPLINK COVERAGES

(71) Applicant: QUALCOMM Incorporated, San Diego, CA (US)

(72) Inventors: Ahmed ELSHAFIE, San Diego, CA (US); Alexandros MANOLAKOS, Escondido, CA (US); Seyedkianoush HOSSEINI, San Diego, CA (US); Yi HUANG, San Diego, CA (US)

(21) Appl. No.: 18/255,568

(22) PCT Filed: Dec. 15, 2021
(86) PCT No.: PCT/US21/63621

§ 371 Date: Jun. 1, 2023

(30) Foreign Application Priority Data
Feb. 4, 2021 (GR) 20210100076

(51) Int. Cl. H04B 7/06

(52) U.S. Cl. CPC H04B 7/0626; H04B 7/0617

(57) ABSTRACT

Aspects relate to mechanisms for improved uplink and sidelink coverages. A first network entity determines one or more channel state feedback (CSF) parameters of one or more beams associated with the first network entity, selects one or more beam coefficients based on the one or more CSF parameters, and transmits the one or more beam coefficients to at least a second network entity. The second network entity selects one or more beams for beaming forming based on the one or more beam coefficients, determines one or more CSF parameters of the one or more beams associated with the second network entity, and transmits the one or more CSF parameters of the one or more beams associated with the second network entity to the first network entity. The first network entity selects one or more new beam coefficients based on the one or more CSF parameters from the second network entity.

### CROSS-REFERENCE TO RELATED APPLICATIONS

This application claims priority to and the benefit of Greece Application Serial No. 20210100076 filed in the Greece Patent Office on Feb. 4, 2021, the entire contents of which are incorporated herein by reference as if fully set forth below in their entireties and for all applicable purposes.

### TECHNICAL FIELD

The technology discussed below relates generally to wireless communication systems, and more particularly, to iterative precoder computation and coordination for improved sidelink (SL) and uplink (UL) coverages.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE). In some wireless communications systems, a UE may transmit and receive messages within a vehicle-to-everything (V2X) sidelink network. For example, one or more UEs may relay transmissions between each other while minimizing or reducing a number of uplink transmissions.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A method of wireless communication operable at a first network entity is provided. The method includes determining one or more channel state feedback (CSF) parameters of one or more beams associated with the first network entity. The method also includes selecting one or more beam coefficients based on the one or more CSF parameters. The method further includes transmitting the one or more beam coefficients to at least a second network entity.

In some aspects, the method further includes selecting one or more ports for beamforming based on the one or more beam coefficients. In some aspects, the method further includes receiving one or more additional CSF parameters from the second network entity in response to transmitting the one or more beam coefficients to at least the second network entity and selecting one or more new beam coefficients based on at least the one or more additional CSF parameters. In some aspects, selecting the one or more new beam coefficients is also based on the one or more CSF parameters. In some aspects, the method further includes selecting one or more new ports for beamforming based on the one or more new beam coefficients. In some aspects, the one or more additional CSF parameters include at least one of one or more transmission configuration indicators (TCI) state or one or more analog beamformers. In some aspects, the one or more CSF parameters are codebook based and include a report that includes at least one of precoding matrix indicator (PMI), channel quality information (CQI), rank indication (RI), reference signal received power (RSRP), or an indication of at least one wideband (WB) beam. In some aspects, the one or more CSF parameters comprise one or more quantized versions of beams.

In some aspects, the first network entity is capable of determining CSF parameters at a quicker rate compared to the second network entity. In some aspects, the method further includes receiving a control signal via at least one of radio resource control (RRC) signaling, medium access control (MAC) control element (MAC-CE) signal, sidelink control information (SCI), or downlink control information (DCI) and after transmitting the one or more beam coefficients to at least the second network entity, repeating, based on the control signal, the steps of determining one or more channel state feedback (CSF) parameters of one or more beams associated with the first network entity, selecting one or more beam coefficients based on the one or more CSF parameters, and transmitting the one or more beam coefficients to at least the second network entity. In some aspects, the method further includes storing the selected one or more beam coefficients and transmitting the one or more beam coefficients to at least a third network entity after transmitting the one or more beam coefficients to at least the second network entity. In some aspects, transmitting the one or more beam coefficients to at least the second network entity comprises transmitting an identity of the first network entity. In some aspects, transmitting the one or more beam coefficients to at least the second network entity comprises transmitting average covariance matrices of one or more channels.

A method of wireless communication operable at second network entity is provided. The method includes receiving one or more beam coefficients associated with at least a first network entity of one or more network entities. The method also includes selecting one or more beams for beamforming based on the one or more beam coefficients.

In some aspects, the method further includes determining one or more channel state feedback (CSF) parameters of the one or more beams associated with the one or more beam coefficients and transmitting the one or more CSF parameters to the first network entity. In some aspects, the method further includes transmitting an indication of the one or more beams for beamforming based on the one or more beam coefficients to at least the first network entity. In some aspects, the method further includes receiving a control signal via at least one of radio resource control (RRC) signaling, medium access control (MAC) control element (MAC-CE) signal, sidelink control information (SCI), or downlink control information (DCI) and after transmitting the one or more CSF parameters to the first network entity, repeating, based on the control signal, the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, and transmitting the one or more CSF parameters to the first network entity. In some aspects, the method further includes selecting one or more ports for beamforming based on the one or more beam coefficients.

In some aspects, the one or more CSF parameters comprise at least one of one or more transmission configuration indicators (TCI) state or one or more analog beamformers. In some aspects, the one or more CSF parameters are codebook based and include a report that includes at least one of precoding matrix indicator (PMI), channel quality information (CQI), rank indication (RI), reference signal received power (RSRP), or an indication of at least one wideband (WB) beam. In some aspects, the one or more CSF parameters comprise one or more quantized versions of beams. In some aspects, the first network entity is capable of determining CSF parameters at a quicker rate compared to the second network entity. In some aspects, receiving the one or more beam coefficients from the first network entity comprises receiving an identity of the first network entity. In some aspects, receiving the one or more beam coefficients from the first network entity comprises receiving average covariance matrices of one or more channels.

A first network entity in a wireless communication system is provided. The first network entity includes a wireless transceiver. The first network entity also includes a memory. The first network entity further includes a processor communicatively coupled to the wireless transceiver and the memory. The processor and the memory are configured to determine one or more channel state feedback (CSF) parameters of one or more beams associated with the first network entity. The processor and the memory are also configured to select one or more beam coefficients based on the one or more CSF parameters. The processor and the memory are further configured to transmit the one or more beam coefficients to at least a second network entity.

A second network entity in a wireless communication system is provided. The second network entity includes a wireless transceiver. The second network entity also includes a memory. The second network entity further includes a processor communicatively coupled to the wireless transceiver and the memory. The processor and the memory are configured to receive one or more beam coefficients associated with at least a first network entity of one or more network entities. The processor and the memory are also configured to select one or more beams for beamforming based on the one or more beam coefficients.

A first network entity is provided. The first network entity includes a means for determining one or more channel state feedback (CSF) parameters of one or more beams associated with the first network entity. The first network entity also includes a means for selecting one or more beam coefficients based on the one or more CSF parameters. The first network entity further includes a means for transmitting the one or more beam coefficients to at least a second network entity.

A second network entity is provided. The second network entity includes a means for receiving one or more beam coefficients associated with at least a first network entity of one or more network entities. The second network entity also includes a means for selecting one or more beams for beamforming based on the one or more beam coefficients.

A non-transitory, processor-readable storage medium of a first network entity having instructions stored thereon is provided. The instructions, when executed by a processing circuit, cause the processing circuit to determine one or more channel state feedback (CSF) parameters of one or more beams associated with the first network entity. The instructions, when executed by the processing circuit, also cause the processing circuit to select one or more beam coefficients based on the one or more CSF parameters. The instructions, when executed by the processing circuit, further cause the processing circuit to transmit the one or more beam coefficients to at least a second network entity.

A non-transitory, processor-readable storage medium of a second network entity having instructions stored thereon is provided. The instructions, when executed by a processing circuit, cause the processing circuit to receive one or more beam coefficients associated with at least a first network entity of one or more network entities. The instructions, when executed by the processing circuit, also cause the processing circuit to select one or more beams for beamforming based on the one or more beam coefficients.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram illustrating an example of a wireless communication system for facilitating both cellular and sidelink communication according to some aspects.

FIG. 4 is a block diagram illustrating a wireless communication system supporting multiple-input multiple-output (MIMO) communication according to some aspects.

FIG. 5 is a diagram illustrating an example of communication between a base station and at least two user equipment (UEs) using beamforming according to some aspects.

FIG. 6 is a schematic illustration of an organization of wireless resources in an air interface utilizing orthogonal frequency divisional multiplexing (OFDM) according to some aspects.

FIG. 7 is a schematic illustration of an OFDM air interface utilizing a scalable numerology according to some aspects.

FIG. 8A illustrates an example allocated resource according to some aspects.

FIG. 8B illustrates an example slot structures according to some aspects.

FIG. 8C illustrates another example slot structures according to some aspects.

FIG. 9 is a diagram illustrating another example of a wireless communication system for facilitating both cellular and sidelink communication according to some aspects.

FIG. 10A is a diagram illustrating another example of a wireless communication system for facilitating both cellular and sidelink communication according to some aspects.

FIG. 10B is a diagram illustrating another example of a wireless communication system for facilitating both cellular and sidelink communication according to some aspects.

FIG. 10C is a diagram illustrating another example of a wireless communication system for facilitating sidelink communication according to some aspects.

FIG. 11 is another conceptual signaling diagram illustrating an example environment for iterative precoders computation and coordination for sidelink and uplink coverages according to some aspects.

FIG. 12 is a block diagram conceptually illustrating an example of a hardware implementation for a first network entity according to some aspects.

FIG. 13 is a flow chart of a method for iterative precoders computation and coordination for sidelink and uplink coverages according to some aspects.

FIG. 14 is a flow chart of another method for iterative precoders computation and coordination for sidelink and uplink coverages according to some aspects.

FIG. 15 is a flow chart of another method for iterative precoders computation and coordination for sidelink and uplink coverages according to some aspects.

FIG. 16 is a flow chart of another method for iterative precoders computation and coordination for sidelink and uplink coverages according to some aspects.

FIG. 17 is a flow chart of another method for iterative precoders computation and coordination for sidelink and uplink coverages according to some aspects.

FIG. 18 is a block diagram conceptually illustrating an example of a hardware implementation for a second network entity according to some aspects.

FIG. 19 is a flow chart of a method for iterative precoders computation and coordination for sidelink and uplink coverages according to some aspects.

FIG. 20 is a flow chart of another method for iterative precoders computation and coordination for sidelink and uplink coverages according to some aspects.

FIG. 21 is a flow chart of another method for iterative precoders computation and coordination for sidelink and uplink coverages according to some aspects.

FIG. 22 is a flow chart of another method for iterative precoders computation and coordination for sidelink and uplink coverages according to some aspects.

FIG. 23 is a flow chart of another method for iterative precoders computation and coordination for sidelink and uplink coverages according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE). In some wireless communications systems, a UE may transmit and receive messages within a vehicle-to-everything (V2X) sidelink network. For example, one or more UEs may relay transmissions between each other while minimizing or reducing a number of uplink transmissions.

Precoding may include beamforming to support multi-stream (or multi-layer) transmission in multi-antenna wireless communications. In some aspects, for single-stream beamforming, a same signal may be emitted from each of the transmit antennas with appropriate weighting (e.g., phase and gain) such that the signal power is maximized at the receiver output. When the receiver has multiple antennas, single-stream beamforming may not simultaneously maximize the signal level at all of the receive antennas. In order to maximize the throughput in multiple receive antenna systems, multi-stream transmission may be used. In point-to-point systems, precoding may include multiple data streams that are emitted from transmit antennas with independent and appropriate weightings such that an link throughput is maximized at the receiver output. In multi-user MIMO, the data streams may be intended for different users and some measure of the total throughput may be maximized. Precoding is a technique that may use transmit diversity by weighting the information stream. For example, precoding may include a situation where the transmitter sends the coded information to the receiver to achieve pre-knowledge of the channel. The receiver may be a simple detector, such as a matched filter, and may not have to know the channel state information. This technique may reduce the corrupted effect of the communication channel. Iterative precoding may include a technique where transmitters and receivers repeatedly share coded information (e.g., precoders) to continually maintain pre-knowledge of one or more channels. For example, as described herein transmitters and receivers may implement iterative precoding or may iteratively use precoders by using channel state feedback (CSF) parameters to continually maintain pre-knowledge of one or more channels. A precoder may be used to align the vector containing the transmit symbols with the eigenvector(s) of a channel. In other words, a precoder may be used to transform transmit symbols vector in such a way that the vector reaches the receiver in the strongest form that is possible in the given channel. A precoder may include information used to minimize the error in a receiver output.

In some aspects, relays may utilize one or more same resources and form a virtual super node with a combined total number of transmit antennas as beamformers. In order to achieve strong or optimal performance, coordination and cooperation between relay nodes may be utilized. Improvements to non-codebook-based beamforming and codebook-based beamforming may be used among two or more network entities (e.g., two or more UEs such as a first UE (UE1) and a second UE (UE2)) by assuming iterative sharing of channel state feedback (CSF) parameters or computations among the two or more network entities. The improvements to non-codebook-based beamforming and codebook-based beamforming may be applied to both sidelink (SL, PC5) relaying and uplink (UL) coverage (Uu) relaying.

In some aspects, a first UE and a second UE may each have a quantity of transmit antennas, for example, as same quantity of transmit antennas. The first UE and the second UE together may be equivalent to a single UE with the twice the quantity of transmit antennas as either the first UE or the second UE alone. Thus, when both the first UE and the second UE know the best precoders among both the first UE and the second UE, the combination of the first UE and the second UE may form a super node of transmit antennas for beamforming. In order to obtain the best precoders, a first UE may determine one or more channel state feedback (CSF) parameters of one or more beams associated with the first UE. The UE may select one or more beam coefficients (in the case of non-codebook-based beamforming) (or may select a beam indices (in this case of codebook-based beamforming)) based on the one or more CSF parameters and transmit the beam coefficients to the second UE. The second UE may receive the one or more beam coefficients from the first UE and select one or more beams for beamforming based on the one or more beam coefficients. The second UE may then determine one or more CSF parameters of the one or more beams associated with the second UE and transmit the one or more CSF parameters determined by the second UE to the first UE. The first UE may then receive the one or more CSF parameters from the second UE and select one or more new beam coefficients based on at least the one or more CSF parameters from the second UE. In some aspects, the first UE may select one or more new beam coefficients based on the one or more CSF parameter from the second UE and the one or more beam coefficients previously selected by the first UE. These steps may be repeated multiple time amongst the first UE and the second UE in order to continuously determine the best beams between the first UE and the second UE and create a super node for beamforming. In some aspects, these steps may be expanded to a plurality of UEs and repeated one or more times in order to continuously determine the best beams between the plurality of UEs and create a super node for beamforming.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

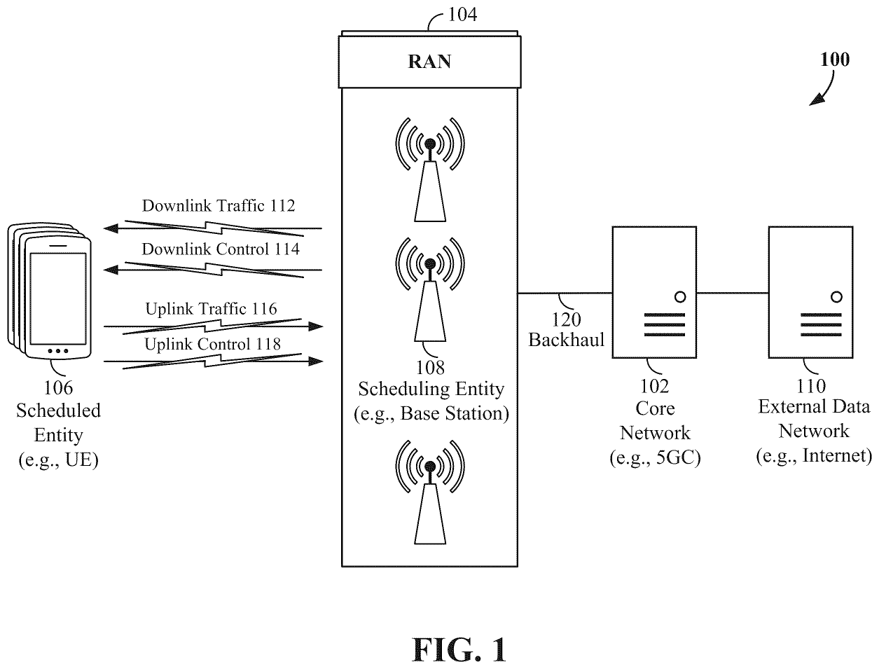

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108 (e.g., a RAN entity, RAN node, or the like). Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, an industrial automation and enterprise device, a logistics controller, agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of lms. Multiple subframes or slots may be grouped together to form a single frame or radio frame. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

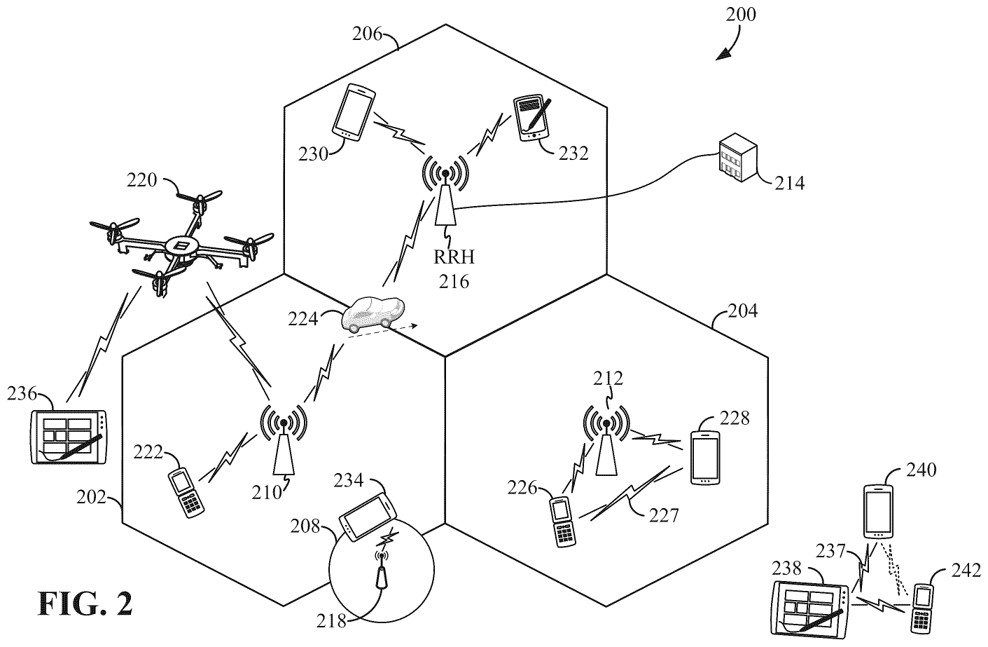

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, and 218 may be configured to provide an access point to a core network (e.g., as illustrated in FIGS. 1 and/or 2) for all the UEs in the respective cells. For example, UEs 222 and 224 may be in communication with base station 210; UEs 226 and 228 may be in communication with base station 412; UEs 230 and 232 may be in communication with base station 214 by way of RRH 216; and UE 234 may be in communication with base station 218. In some examples, the UEs 222, 224, 226, 228, 230, 232, 234, 238, 240, and/or 242 may be the same as the UE/scheduled entity 106 described above and illustrated in FIG. 1.

In some examples, an unmanned aerial vehicle (UAV) 220, which may be a drone or quadcopter, can be a mobile network node and may be configured to function as a UE. For example, the UAV 220 may operate within cell 202 by communicating with base station 210.

Base stations 210, 212, 214, 218 may operate as scheduling entities, scheduling resources for communication among the UEs within their service areas or cells 202, 204, 206, 208, respectively. However, base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 238, 240, and 242) may communicate with each other using peer to peer (P2P) or sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 246. In this example, the base station 212 may allocate resources to the UEs 226 and 228 for the sidelink communication. In either case, such sidelink signaling 227 and 237 may be implemented in a P2P network, a device-to-device (D2D) network, vehicle-to-vehicle (V2V) network, a vehicle-to-everything (V2X), a mesh network, or other suitable direct link network.

In the RAN 200, the ability for a UE to communicate while moving, independent of its location, is referred to as mobility. The various physical channels between the UE and the radio access network are generally set up, maintained, and released under the control of an AMF.

A RAN 200 may utilize DL-based mobility or UL-based mobility to enable mobility and handovers (e.g., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSS s) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

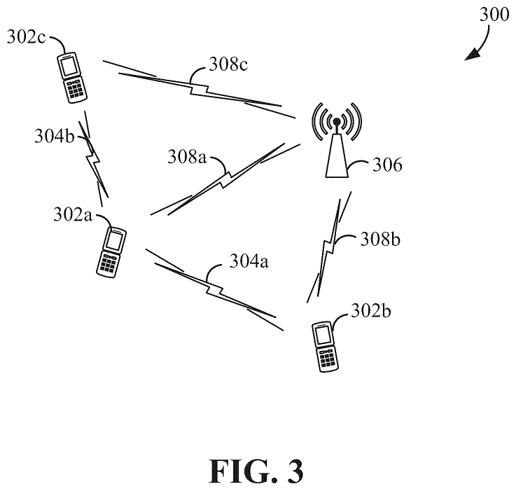

FIG. 3 is a diagram illustrating an example of a wireless communication system 300 for facilitating both cellular and sidelink communication. The wireless communication system 300 includes a plurality of wireless communication devices 302a, 302b, and 302c and a base station (e.g., eNB or gNB) 306. In some examples, the wireless communication devices 302a, 302b, and 302c may be UEs capable of implementing D2D or V2X devices within a V2X network.

The wireless communication devices 302a and 302b may communicate over a first PC5 interface 304a, while wireless communication devices 302a and 302c may communicate over a second PC5 interface 304b. Wireless communication devices 302a, 302b, and 302c may further communicate with the base station 306 over respective Uu interfaces 308a, 308b, and 308b. The sidelink communication over the PC5 interfaces 304a and 304b may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications.

In some examples, a common carrier may be shared between the PC5 interfaces 304a and 304b and Uu interfaces 308a-308c, such that resources on the common carrier may be allocated for both sidelink communication between wireless communication devices 302a-302c and cellular communication (e.g., uplink and downlink communication) between the wireless communication devices 302a-302c and the base station 306. For example, the wireless communication system 300 may be configured to support a V2X network in which resources for both sidelink and cellular communication are scheduled by the base station 306. In other examples, the wireless communication devices 302a-302c may autonomously select sidelink resources (e.g., from one or more frequency bands or sub-bands designated for sidelink communication) for communication therebetween. In this example, the wireless communication devices 302a-302c may function as both scheduling entities and scheduled entities scheduling sidelink resources for communication with each other.

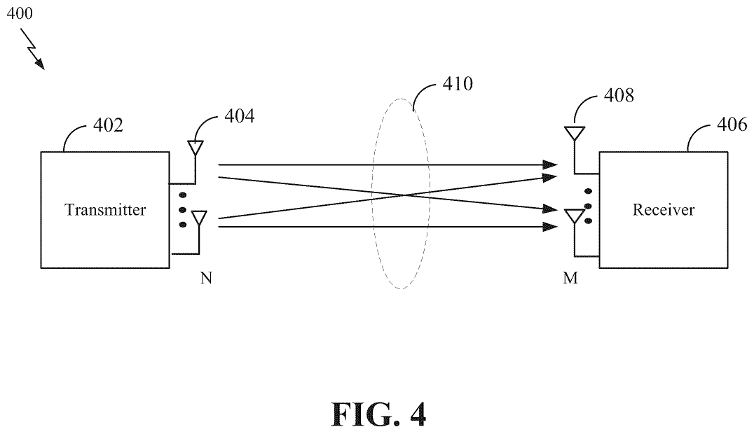

In some aspects of the disclosure, the scheduling entity and/or scheduled entity may be configured for beamforming and/or multiple-input multiple-output (MIMO) technology. FIG. 4 illustrates an example of a wireless communication system 400 supporting MIMO. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. Each of the transmitter 402 and the receiver 406 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (e.g., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 400 is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit a channel state information—reference signal (CSI-RS) with separate C-RS sequences for each layer to provide for multi-layer channel estimation. From the CSI-RS, the UE may measure the channel quality across layers and resource blocks and feedback a channel quality indicator (CQI) and RI values to the base station for use in updating the rank and assigning REs for future downlink transmissions.

In the simplest case, as shown in FIG. 4, a rank-2 spatial multiplexing transmission on a 2×2 MIMO antenna configuration will transmit one data stream from each transmit antenna 404. Each data stream reaches each receive antenna 408 along a different signal path 410. The receiver 406 may then reconstruct the data streams using the received signals from each receive antenna 408.

Beamforming is a signal processing technique that may be used at the transmitter 402 or receiver 406 to shape or steer an antenna beam (e.g., a transmit beam or receive beam) along a spatial path between the transmitter 402 and the receiver 406. Beamforming may be achieved by combining the signals communicated via antennas 404 or 408 (e.g., antenna elements of an antenna array module) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406. A beam may be formed by, but not limited to, an antenna, an antenna port, an antenna element, a group of antennas, a group of antenna ports or a group of antenna elements.

In 5G New Radio (NR) systems, particularly for mmWave systems, beamformed signals may be utilized for most downlink channels, including the physical downlink control channel (PDCCH) and physical downlink shared channel (PDSCH). In addition, broadcast information, such as the SSB, CSI-RS, slot format indicator (SFI), and paging information, may be transmitted in a beam-sweeping manner to enable all scheduled entities (UEs) in the coverage area of a transmission and reception point (TRP) (e.g., a gNB) to receive the broadcast information. In addition, for UEs configured with beamforming antenna arrays, beamformed signals may also be utilized for uplink channels, including the physical uplink control channel (PUCCH) and physical uplink shared channel (PUSCH).

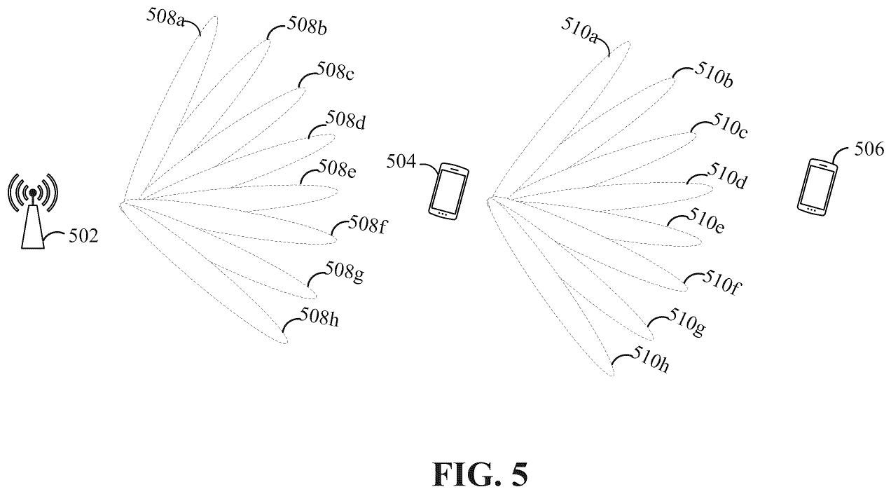

FIG. 5 is a diagram illustrating communication between a radio access network (RAN) node 502, a first wireless communication device 504, and a second wireless communication device 506 using beamformed sidelink signals according to some aspects. Each of the RAN node 502 (e.g., a base station, such as a gNB) and the first wireless communication device 504 may be any of the receiving devices or transmitting devices illustrated in any of FIGS. 1-4. Each of the first wireless communication device 504 and the second wireless communication device 506 may be any of the UEs, V2X devices, transmitting devices or receiving devices illustrated in any of FIGS. 1-4.

In the example shown in FIG. 5, the radio access network (RAN) node 502 and the first wireless communication device 504 may be configured to communicate access (e.g., Uu) signals on one or more of a plurality of beams 508a, 508b, 508c, 508d, 508e, 508f, 508g, and 508h. Although the beams 508a, 508b, 508c, 508d, 508e, 508f, 508g, and 508h are illustrated in FIG. 5 as being generated on the RAN node 502, it should be understood that the same concepts described herein apply to beams generated on the first wireless communication device 504. For example, each of the RAN node 502 and the first wireless communication device 504 may select one or more beams to transmit access signals to the other communication device. In some examples, due to channel reciprocity, the selected beam(s) on each of the RAN node 502 and the first wireless communication device 504 may be used for both transmission and reception of access signals. It should be noted that while some beams are illustrated as adjacent to one another, such an arrangement may be different in different aspects. In some examples, the RAN node 502 and the first wireless communication device 504 may generate more or less beams distributed in different directions.

The number of beams on which a particular RAN node 502 or the first wireless communication device 504 may simultaneously communicate may be defined based on NR standards and specifications and capabilities of the RAN node 502 and the first wireless communication device 504. For example, the number of beams may be determined based on a number of antenna panels configured on the RAN node 502 or the first wireless communication device 504. Each beam may be utilized, for example, to transmit a respective layer for MIMO communication.

In some examples, to select one or more beams for communication on a access link between the RAN node 502 and the first wireless communication device 504, the RAN node 502 may transmit an access reference signal, such as an access synchronization signal block (SSB) or an access channel state information (CSI) reference signal (RS), on each of the plurality of beams 508a, 508b, 508c, 508d, 508e, 508f, 508g, and 508h in a beam-sweeping manner towards the first wireless communication device 504. The first wireless communication device 504 searches for and identifies the beams based on the beam reference signals. The first wireless communication device 504 then performs beam measurements (e.g., reference signal received power (RSRP), signal-to-interference-plus-noise ratio (SINR), reference signal received quality (RSRQ), etc.) on the beam reference signals to determine the respective beam quality of each of the beams.

The first wireless communication device 504 may then transmit a beam measurement report to the RAN node 502 indicating the beam quality of one or more of the measured beams. The RAN node 502 may then select the particular beam(s) for communication between the RAN node 502 and the first wireless communication device 504 on the access link based on the beam measurement report. The RAN node 502 may then signal the selected beam(s) via, for example, a radio resource control (RRC) message or via a medium access control (MAC) control element (CE).

Each selected beam on one of the communication devices (e.g., the RAN node 502 or the first wireless communication device 504) may form a beam pair link (BPL) with a corresponding selected beam on the other communication device. Thus, each BPL includes corresponding transmit and receive beams on the RAN node 502 and the first wireless communication device 504. For example, a BPL may include a first transmit/receive beam on the RAN node 502 and a second transmit/receive beam on the first wireless communication device 504. To increase the data rate, multiple BPLs can be used to facilitate spatial multiplexing of multiple data streams. In some examples, the different BPLs can include beams from different antenna panels.

Also, in the example shown in FIG. 5, the first wireless communication device 504 and the second wireless communication device 506 may be configured to communicate sidelink signals on one or more of a plurality of beams 510a, 510b, 510c, 510d, 510e, 510f, 510g, and 510h. Although the beams 510a, 510b, 510c, 510d, 510e, 510f, 510g, and 510h are illustrated in FIG. 5 as being generated on the first wireless communication device 504, it should be understood that the same concepts described herein apply to beams generated on the second wireless communication device 506. For example, each of the first wireless communication device 504 and the second wireless communication device 506 may select one or more beams to transmit sidelink signals to the other wireless communication device. In some examples, due to channel reciprocity, the selected beam(s) on each of the first wireless communication device 504 and the second wireless communication device 506 may be used for both transmission and reception of sidelink signals. It should be noted that while some beams are illustrated as adjacent to one another, such an arrangement may be different in different aspects. In some examples, the first wireless communication device 504 and the second wireless communication device 506 may generate more or less beams distributed in different directions.

The number of beams on which a particular first wireless communication device 504 or the second wireless communication device 506 may simultaneously communicate may be defined based on NR SL standards and specifications and capabilities of the first wireless communication device 504 and the second wireless communication device 506. For example, the number of beams may be determined based on a number of antenna panels configured on the first wireless communication device 504 or the second wireless communication device 506. Each beam may be utilized, for example, to transmit a respective layer for MIMO communication.

In some examples, to select one or more beams for communication on a sidelink between the first wireless communication device 504 and the second wireless communication device 506, the first wireless communication device 504 may transmit a sidelink reference signal, such as a sidelink synchronization signal block (SSB) or sidelink channel state information (CSI) reference signal (RS), on each of the plurality of beams 510a, 510b, 510c, 510d, 510e, 510f, 510g, and 510h in a beam-sweeping manner towards the second wireless communication device 506. The second wireless communication device 506 searches for and identifies the beams based on the beam reference signals. The second wireless communication device 506 then performs beam measurements (e.g., reference signal received power (RSRP), signal-to-interference-plus-noise ratio (SINR), reference signal received quality (RSRQ), etc.) on the beam reference signals to determine the respective beam quality of each of the beams.

The second wireless communication device 506 may then transmit a beam measurement report to the first wireless communication device 504 indicating the beam quality of one or more of the measured beams. The first wireless communication device 504 may then select the particular beam(s) for communication between the first wireless communication device 504 and the second wireless communication device 506 on the sidelink based on the beam measurement report. For example, the first wireless communication device 504 may forward the beam measurement report to a base station for selection of the beam(s). The base station may then signal the selected beam(s) via, for example, a radio resource control (RRC) message or via a medium access control (MAC) control element (CE).

Each selected beam on one of the wireless communication devices (e.g., the first wireless communication device 504 or the second wireless communication device 506) may form a beam pair link (BPL) with a corresponding selected beam on the other wireless communication device. Thus, each BPL includes corresponding transmit and receive beams on the first wireless communication device 502 and the second wireless communication device 506. For example, a BPL may include a first transmit/receive beam on the first wireless communication device 504 and a second transmit/receive beam on the second wireless communication device 506. To increase the data rate, multiple BPLs can be used to facilitate spatial multiplexing of multiple data streams. In some examples, the different BPLs can include beams from different antenna panels.

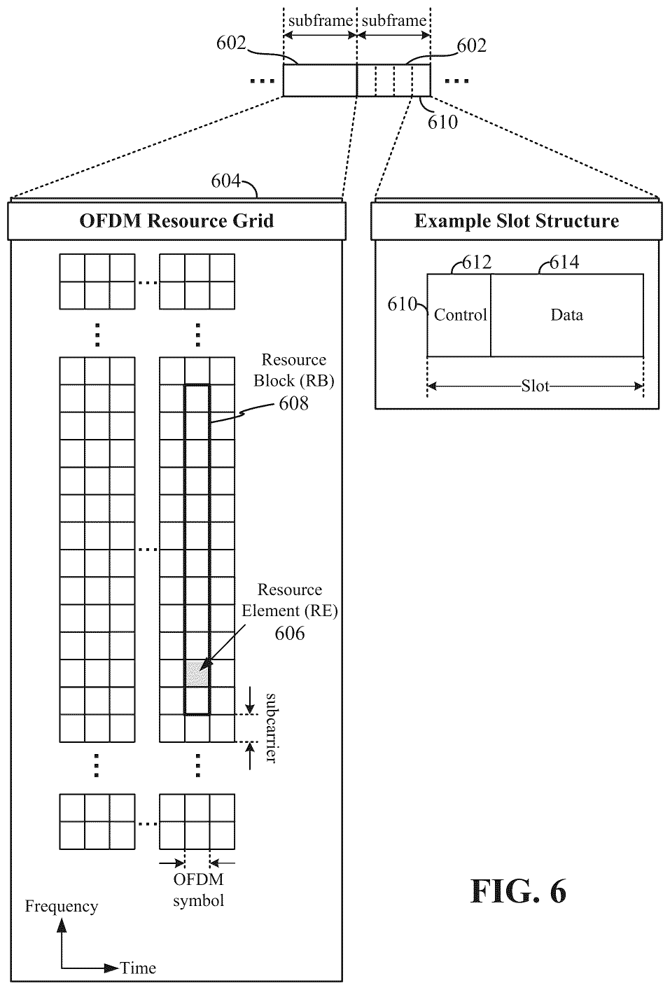

Various aspects of the present disclosure will be described with reference to an OFDM waveform, schematically illustrated in FIG. 6. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 6, an expanded view of an exemplary subframe 602 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 604 may be used to schematically represent time-frequency resources for a given antenna port. That is, in a multiple-input-multiple-output (MIMO) implementation with multiple antenna ports available, a corresponding multiple number of resource grids 604 may be available for communication. The resource grid 604 is divided into multiple resource elements (REs) 606. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or a resource block (RB) 608, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 608 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs (e.g., scheduled entities) for downlink or uplink transmissions typically involves scheduling one or more resource elements 606 within one or more sub-bands or BWPs. Thus, a UE generally utilizes only a subset of the resource grid 604. In some examples, an RB may be the smallest unit of resources that can be allocated to a UE. Thus, the more RBs scheduled for a UE, and the higher the modulation scheme chosen for the air interface, the higher the data rate for the UE.

In this illustration, the RB 608 is shown as occupying less than the entire bandwidth of the subframe 602, with some subcarriers illustrated above and below the RB 608. In a given implementation, the subframe 602 may have a bandwidth corresponding to any number of one or more RBs 608. Further, in this illustration, the RB 608 is shown as occupying less than the entire duration of the subframe 602, although this is merely one possible example.

Each 1 ms subframe 602 may consist of one or multiple adjacent slots. In the example shown in FIG. 6, one subframe 602 includes four slots 610, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 610 illustrates the slot 610 including a control region 612 and a data region 614. In general, the control region 612 may carry control channels, and the data region 614 may carry data channels. Of course, a slot may contain all DL, all UL, or at least one DL portion and at least one UL portion. The structure illustrated in FIG. 6 is merely exemplary in nature, and different slot structures may be utilized, and may include one or more of each of the control region(s) and data region(s).

Although not illustrated in FIG. 6, the various REs 606 within a RB 608 may be scheduled to carry one or more physical channels, including control channels, shared channels, data channels, etc. Other REs 606 within the RB 608 may also carry pilots or reference signals. These pilots or reference signals may provide for a receiving device to perform channel estimation of the corresponding channel, which may enable coherent demodulation/detection of the control and/or data channels within the RB 608.

In some examples, the slot 610 may be utilized for broadcast or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 606 (e.g., within the control region 612) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 606 (e.g., in the control region 612 or the data region 614) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 140 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESETO), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

In an UL transmission, the scheduled entity (e.g., UE) may utilize one or more REs 606 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), e.g., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 606 (e.g., within the data region 614) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 606 within the data region 614 may be configured to carry other signals, such as one or more SIB s and DMRSs.

In an example of sidelink communication over a sidelink carrier via a proximity service (ProSe) PC5 interface, the control region 612 of the slot 610 may include a physical sidelink control channel (PSCCH) including sidelink control information (SCI) transmitted by an initiating (transmitting) sidelink device (e.g., V2X or other sidelink device) towards a set of one or more other receiving sidelink devices. The data region 614 of the slot 610 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 606 within slot 610. For example, HARQ feedback information may be transmitted in a physical sidelink feedback channel (PSFCH) within the slot 610 from the receiving sidelink device to the transmitting sidelink device. In addition, one or more reference signals, such as a sidelink SSB and/or a sidelink CSI-RS, may be transmitted within the slot 610.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RB s in a given transmission.

The channels or carriers described herein are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

In OFDM, to maintain orthogonality of the subcarriers or tones, the subcarrier spacing may be equal to the inverse of the symbol period. A numerology of an OFDM waveform refers to its particular subcarrier spacing and cyclic prefix (CP) overhead. A scalable numerology refers to the capability of the network to select different subcarrier spacings, and accordingly, with each spacing, to select the corresponding symbol duration, including the CP length. With a scalable numerology, a nominal subcarrier spacing (SCS) may be scaled upward or downward by integer multiples. In this manner, regardless of CP overhead and the selected SCS, symbol boundaries may be aligned at certain common multiples of symbols (e.g., aligned at the boundaries of each 1 ms subframe). The range of SCS may include any suitable SCS. For example, a scalable numerology may support a SCS ranging from 15 kHz to 480 kHz.

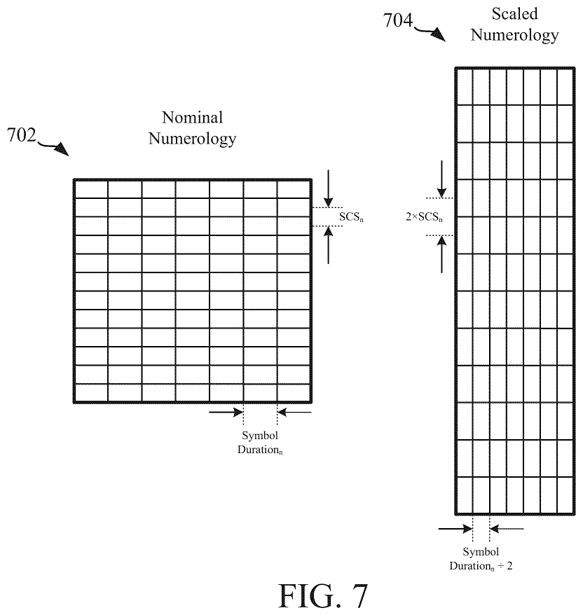

To illustrate this concept of a scalable numerology, FIG. 7 shows a first RB 702 having a nominal numerology, and a second RB 704 having a scaled numerology. As one example, the first RB 702 may have a ‘nominal’ subcarrier spacing (SCSₙ) of 30 kHz, and a ‘nominal’ symbol durationₙ of 333 μs. Here, in the second RB 704, the scaled numerology includes a scaled SCS of double the nominal SCS, or 2×SCSₙ=60 kHz. Because this provides twice the bandwidth per symbol, it results in a shortened symbol duration to carry the same information. Thus, in the second RB 704, the scaled numerology includes a scaled symbol duration of half the nominal symbol duration, or (symbol durationₙ)±2=167 μs.

5G NR V2X may have at least two modes of operation for allocating resources that are supported for NR sidelink (SL) communication. The first mode may include a scenario where a base station allocates resources for SL communication between two or more user equipment (UEs). The second mode may include a scenario where two or more UEs autonomously select SL resources. In both scenarios, signaling on SL may be the same or at least similar. For example, from a perspective of a UE receiving an indication or allocated resources, there may be no difference between the first mode and the second mode. It should be understood that NR SL may support HARQ-based retransmissions. Generally, SL communications may occur in transmission resource pools or reception resource pools and a minimum resource allocation unit may be a sub-channel in frequency. In some aspects, resource allocation in time may be one slot and some slots may not be available for SL while others may contain feedback resources. Radio resource control (RRC) configurations may be used for resource allocation and may pre-configured or preloaded into a UE or configured during operation through signaling from a base station or scheduling entity.

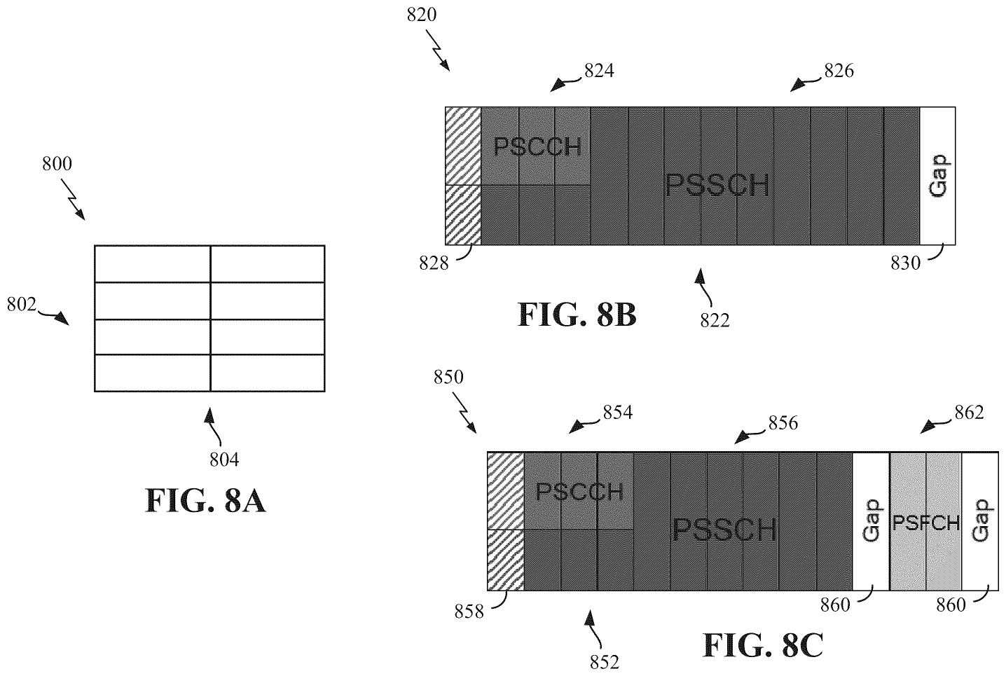

FIG. 8A illustrates an example allocated resource 800 according to some aspects. As shown in FIG. 7, the allocated resource 800 may include a plurality of sub-channels 802 and a plurality of slots 804. Further, as described herein, there are at least four defined physical SL channels: physical sidelink control channel (PSCCH), physical sidelink shared channel (PSSCH), physical sidelink feedback channel (PSFCH), and physical sidelink broadcast channel (PSBCH). There are also several type of reference signals (RS s) that may be used with SL communications including demodulation RS (DM-RS) for PSCCH, DM-RS for PSSCH, DM-RS for PSBCH, channel state information RS (CSI-RS), primary synchronization signals (S-PSS), secondary synchronization signals (S-SSS), and phase-tracking RS (PT-RS) for FR2.

FIG. 8B illustrates an example slot structure 820 according to some aspects. The slot structure 820 may include fourteen (14) OFDM symbols 822, but SL communication may be configured or pre-configured to utilize or occupy fewer than the 14 symbols 822 in the slot structure 820. The slot structure 820 may also include a plurality of PSCCH symbols 824 and a plurality of PSSCH symbols 826. In some aspects, the slot structure 820 may not include feedback resources. In some aspects, PSCCH symbols and PSSCH symbols may always be transmitted in a same slot. A first symbol 828 may be repeated on a preceding symbol for automatic gain control (AGC) settling and a gap symbol 830 may be located after the plurality of PSSCH symbols 826. In some aspects, sub-channel size may be configured or pre-configured to 10, 15, 20, 25, 50, 75, or 100 physical resource blocks (PRBs).

With respect to the plurality of PSCCH symbols 824, the PSCCH symbol duration may be configured or pre-configured to 2 or 3 symbols. The plurality of PSCCH symbols 824 may be pre-configured to span 10, 12, 15, 20, or 25 PRBs and may be limited to a single sub-channel. A DM-RS may be present in every PSCCH symbol and located in every four resource elements (REs). A frequency domain orthogonal coverage code (FD-OCC) may be applied to the DM-RS to reduce impact of colliding PSCCH transmissions. For example, a transmitting UE may randomly select from a set of one or more pre-defined FD-OCCs. The plurality of PSCCH symbols 824 may be located after the first symbol 828 (e.g., at a second symbol) of the slot structure 820.

Sidelink control information may be used in at least two stages for forward capability. For example, first stage control information (SCI-1) may be transmitted on PSCCH and may contain information for resource allocation and decoding second stage control information (SCI-2). SCI-2 may be transmitted on PSSCH and may contain information for decoding data (shared channel (SCH)). In some aspects, SCI-1 may be decodable by all UEs and new SCI-2 formats may be introduced to facility introductions to new features while avoiding resource collisions between releases. In some aspects, both SCI-1 and SCI-2 may use a PDCCH polar code. In some aspects, SCI-1 content may include a priority (e.g., a quality of service (QoS)) value, PSSCH resource assignment (e.g., frequency/time resources for PSSCH), a resource reservation period (e.g., if enabled), a PSSCH DM-RS pattern (if more than one pattern is pre-configured), a format for SCI-2 (e.g., information on a size of SCI-2), 2-bit beta offset for SCI-2 resource allocation, a number of PSSCH DMRS ports (e.g., 1 or 2), and a 5-bit modulation and coding scheme (MCS). SCI-2 formats may have one or more characteristics including a HARQ process identification (ID), a network device interface (NDI), a source ID, a destination ID, and a CSI report trigger (e.g., applicable in unicast). For groupcast (NACK-only distance-based feedback), SCI-2 formats may include a zone ID indicating a location of the transmitting UE and a maximum communication range for sending feedback.

With respect to the plurality of PSSCH symbols 826, one or two layer transmissions may be supported with quadrature phase shift keying (QPSK), 16-quadrature amplitude modulation (16-QAM), 64-QAM, and 256-QAM. The plurality of PSSCH symbols 826 may include 2, 3, and 4 symbol DM-RS patterns that can be pre-configured for use by a transmitting UE. In some aspects, a transmitting UE may select a DM-RS pattern and signal that DM-RS pattern in first stage control information (SCI-1), described herein, according to channel conditions. DM-RS patterns for 12 and 9 symbol PSSCH as well as patterns for other lengths may be also be used. For the plurality of PSSCH symbols 826, second stage control information (SCI-2), described herein, may be used. Starting from a first symbol with PSSCH DM-RS in PSSCH, SCI-2 may be mapped to contiguous resource blocks (RBs). SCI-2 may also be scrambled separately from a sidelink shared channel (SL-SCH). In some aspects, SCI-2 may always use QPSK. In some aspects, SCI-2 may not utilize blind coding. For example, an SCI-2 format may be indicated in SCI-1. As another example, a number of REs may be derived from SCI-1 content. As yet another example, SCI-2 may have a known starting location. When an SL-SCH transmission is on two layers, SCI-2 modulation symbols may be copied on both layers.

FIG. 8C illustrates an example slot structure 850 structure according to some aspects. The slot structure 850 may include one or more of the same or similar features described herein with respect of the slot structure 820 of FIG. 8B. For example, the slot structure 850 may include fourteen (14) OFDM symbols 852, a plurality of PSCCH symbols 854, a plurality of PSSCH symbols 856, a first symbol 858 that may be repeated on a preceding symbol for automatic gain control (AGC) settling, and a gap symbol 860 that may be located after the plurality of PSSCH symbols 856. In addition, the slot structure 850 may include one or more PSFCH symbols 862. The one or more PSFCH symbols 862 may be located after the gap symbol 860. The one or more PSFCH symbols 862 may have resources that can be configured with a period of 0, 1, 2, or 4 slots. An ODFM symbol for PSFCH may be a symbol that is dedicated only to PSFCH. A PSFCH symbol of the one or more PSFCH symbols 862 may be a repetition of the second for AGC settling. In some aspects, another gap symbol 864 may be located after the one or more PSFCH symbols 862.

With respect to PSFCH, feedback resource may be used system wide and may be configured or pre-configured with a period of 1, 2, or 4 slots. In some aspects, three (3) ODFM symbols may be occupied if configured with one (1) gap symbol and two (2) PSFCH symbols. In some aspects, a number of PRBs for the PSFCH may be configured or pre-configured using a bitmap. For PUCCH format zero (0) on one RB may carrier HARQ-ACK information for a signal PSSCH transmission. The PSFCH format zero (0) sequence may be repeated on two (2) PSFCH symbols. In some aspects, PSFCH may be enabled for unicast and groupcast. In some aspects, PSFCH may be one (1) bit ACK/NACK for unicast. In some aspects, PDSCH for groupcast may have at least two feedback modes: a first mode including where a receiving UE transmits only a NACK transmission and a second mode include where a receiving UE transmits either an ACK transmission or a NACK transmission. In some aspects, there may be a mapping between PSSCH and a corresponding PSFCH. The mapping between PSSCH and the corresponding PSFCH may be based on at least one of a starting sub-channel of PSSCH, a slot containing PSSCH, a source ID, a destination ID, or the like. A number of available PSFCH resources may be equal to or greater than a number of UEs in groupcast using the second where a receiving UE transmit either an ACK transmission or a NACK transmission.

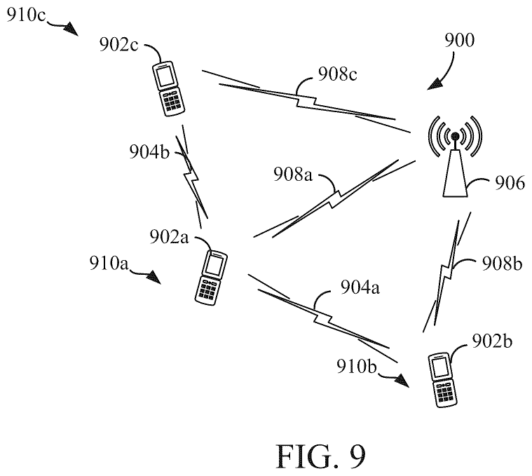

FIG. 9 is a diagram illustrating another example of a wireless communication system 900 for facilitating both cellular and sidelink communication according to some aspects. The wireless communication system 900 includes a plurality of wireless communication devices including a first UE 902a, a second UE 902b, and a third UE 902c and a base station (e.g., eNB or gNB) 906. In some examples, the first UE 902a, the second UE 902b, and the third UE 902c may be UEs capable of implementing D2D or V2X devices within a V2X network. The wireless communication system 900 may include one or more of the same or similar features as described herein with respect to at least the wireless communication system 300 illustrated in FIG. 3.

In some aspects, the wireless communication system 900 may provide one or more examples of UE relaying for UL coverage enhancement. For example, the wireless communication system 900 may include dedicated UL tunneling via UE relays. In some aspects, the base station 906 may use broadcast/groupcast to quickly set up a multi-hop tunneling (via UE relays) in dedicated time-frequency resources. For example, the base station 906 may utilize a first Uu interface 908a, a second UU interface 908b, and a third Uu interface 908c to broadcast multi-hop tunneling set-up in dedicated time-frequency resources to each of the first UE 902a, the second UE 902b, and the third UE 902c. Subsequently, based on the multi-hop tunneling set-up indicated by the base station 906, the second UE 902b may communicate with the base station 906 via only a first SL interface 904a to the first UE 902a and then via a second SL interface 904b to the third UE 902c, and then via the third Uu interface 908c to the base station 906. In some aspects, the first SL interface 904a and the second SL interface 904b may form a short time, wideband dedicated UL tunnel. In some aspects, the base station 906 may also restrict a number of hops to one remote UE and only one relay UE.

In some aspects, the first UE 902a, the second UE 902b, and the third UE 902c may each have direct links to the base station 906 and a single next UE but no other UEs. For example, the third UE 902c may have direct links to the base station 906 via the third Uu interface 908c and the first UE 902a via the second SL interface 904b, but may have no direct link to the second UE 902b. In some aspects, each of the first UE 902a, the second UE 902b, and the third UE 902c may have direct links to each other regardless of the hop number. For example, the first UE 902a may have a direct link with each of the second UE 902b and the third UE 902c. In addition, the second UE 902b may have a direct link the third UE 902c that does not go through another UE such as the first UE 902a. In some aspects, UEs may be grouped where each group may communicate with a next closest group so that from one group to one group there is only one hop. For example, each of the first UE 902a, the second UE 902b, and the third UE 902c may represent a plurality of UEs grouped into a first group 910a, second group 910b, and third group 910c, respectively. The first group 910a may have a direct link with each of the second group 910b and the third group 910c so that there is a single hop between groups.

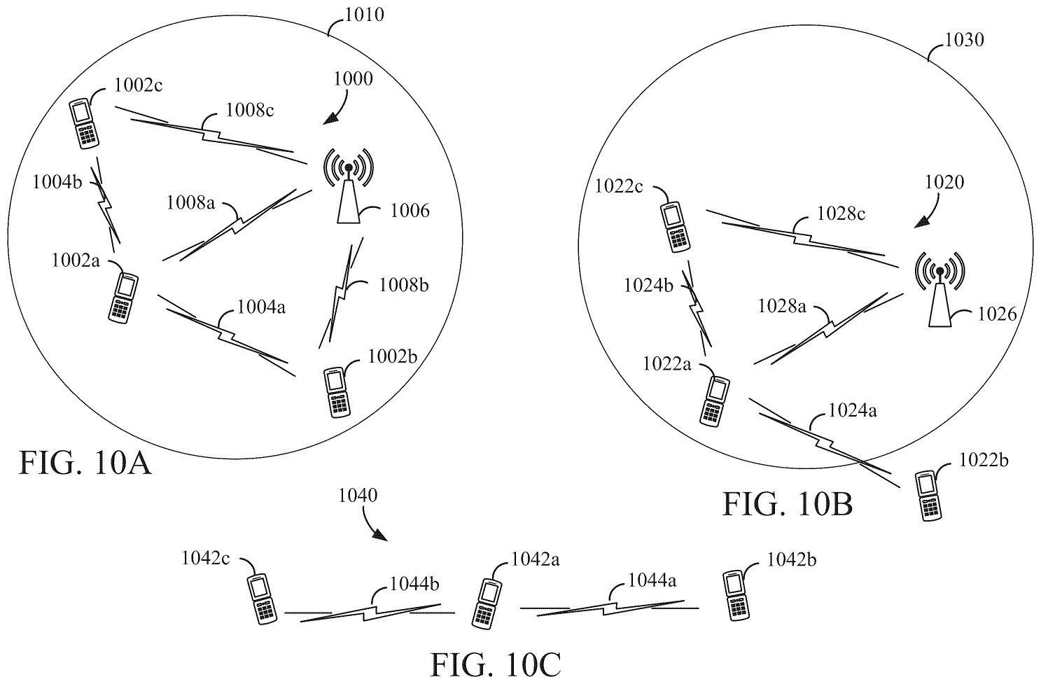

FIG. 10A is a diagram illustrating another example of a wireless communication system 1000 for facilitating both cellular and sidelink communication according to some aspects. The wireless communication system 1000 includes a plurality of wireless communication devices including a first UE 1002a, a second UE 1002b, and a third UE 1002c and a base station (e.g., eNB or gNB) 1006. In some examples, the first UE 1002a, the second UE 1002b, and the third UE 1002c may be UEs capable of implementing D2D or V2X devices within a V2X network. The wireless communication system 1000 may include one or more of the same or similar features as described herein with respect to at least the wireless communication system 300 illustrated in FIG. 3 and the wireless communication system 900 illustrated in FIG. 9. In some aspects, the wireless communication system 1000 may illustrate an in-coverage scenario. For example, as shown in FIG. 10A, the wireless communication system 1000 also includes a coverage area 1010 indicating that the first UE 1002a, the second UE 1002b, and the third UE 1002c are within wireless communication coverage of the base station 1006. In an in-coverage scenario, the first UE 1002a, the second UE 1002b, and the third UE 1002c may each be connected via the first Uu interface 1008a, the second Uu interface 1008b, and the third Uu interface 1008c, respectively via the base station 1006. Sidelink communication authorization and provisioning using a Uu interface may be used to support sidelink operations. The base station 1006 may control the sidelink discovery and communication resource allocation.

The wireless communication system 1000 may also support connectivity for remote UEs to the network via a relay UE in an in-coverage scenario. For example, the first UE 1002a may always be within coverage of the base station 1006 via the first Uu interface 1008a. In an in-coverage scenario, the second UE 1002b and/or the third UE 1002c may also be within the coverage area 1010 and within coverage of the base station 1006. Prioritized one hop relay support as well as multi-hop relay support may be utilized between each of the first UE 1002a, the second UE 1002b, and the third UE 1002c. An uplink (Uu) connection independent (e.g., excluding) a PC5 relay path may also be available for each of the first UE 1002a, the second UE 1002b, and the third UE 1002c and may also follow PC5 in-coverage operations.

In some aspects, the wireless communication system 1000 may support connectivity for remote UEs to the UEs via a relay UE. For example, the first UE 1002a may within coverage of the base station 1006 via the first Uu interface 1008a. The second UE 1002b and/or the third UE 1002c (e.g., a remote UE) may also be within or out of the coverage area 1010. Prioritized one hop relay support as well as multi-hop relay support may be utilized between each of the first UE 1002a, the second UE 1002b, and the third UE 1002c. An uplink (Uu) connection independent (e.g., excluding) a PC5 relay path may also be available for each of the first UE 1002a, the second UE 1002b, and the third UE 1002c and may also follow PC5 in-coverage operations.

FIG. 10B is a diagram illustrating another example of a wireless communication system 1020 for facilitating both cellular and sidelink communication according to some aspects. The wireless communication system 1020 includes a plurality of wireless communication devices including a first UE 1022a, a second UE 1022b, and a third UE 1022c and a base station (e.g., eNB or gNB) 1026. In some examples, the first UE 1022a, the second UE 1022b, and the third UE 1022c may be UEs capable of implementing D2D or V2X devices within a V2X network. The wireless communication system 1020 may include one or more of the same or similar features as described herein with respect to at least the wireless communication system 300 illustrated in FIG. 3, the wireless communication system 900 illustrated in FIG. 9, and the wireless communication system 1000 illustrated in FIG. 10A.

In some aspects, the wireless communication system 1000 may illustrate a partial-coverage scenario. For example, as shown in FIG. 10B, the wireless communication system 1020 also includes a coverage area 1030 indicating that the first UE 1022a and the third UE 1022c are within wireless communication coverage of the base station 1026. However, the second UE 1022b may be out of the coverage area 1030 and beyond wireless communication coverage of the base station 1026. In a partial-coverage scenario, the first UE 1022a and the third UE 1002c may each be connected via the first Uu interface 1028a and the second Uu interface 1028c, respectively, to the base station 1026. Other UEs such as the second UE 1022b may not be in Uu communication with the base station 1026. Instead, the second UE 1022b may connect to the base station 1026 via the first UE 1022a and/or the third UE 1022c acting as relays. Sidelink communication authorization and provisioning using a Uu interface may be used to support sidelink operations. The base station 1006 may control the sidelink discovery and communication resource allocation.

FIG. 10C is a diagram illustrating another example of a wireless communication system 1040 for facilitating sidelink communication according to some aspects. The wireless communication system 1040 includes a plurality of wireless communication devices including a first UE 1042a, a second UE 1042b, and a third UE 1042c. In some examples, the first UE 1042a, the second UE 1042b, and the third UE 1042c may be UEs capable of implementing D2D or V2X devices within a V2X network. The wireless communication system 1040 may include one or more of the same or similar features as described herein with respect to at least the wireless communication system 300 illustrated in FIG. 3, the wireless communication system 900 illustrated in FIG. 9, the wireless communication system 1000 illustrated in FIG. 10A, and the wireless communication system 1020 illustrated in FIG. 10B.

In some aspects, the wireless communication system 1040 may illustrate an out of coverage scenario. For example, as shown in FIG. 10C, the wireless communication system 1020 does not include a base station nor that any of the first UE 1042a, the second UE 1042b, or the third UE 1042c are within a coverage area of a base station. In this scenario, no UE is connected to a base station (e.g., a 5GNR base station) and each of the first UE 1042a, the second UE 1042b, and the third UE 1042c may operate without authorization and provisioning via an uplink communication. Instead, the first UE 1042a, the second UE 1042b, and the third UE 1042c may act as relay for each other via the first sidelink 1044a and the second sidelink 1044b and communication authorization and provisioning may be preconfigured on each of the first UE 1042a, the second UE 1042b, and the third UE 1042c. In some aspects, a relay UE, such as the first UE 1042a, may manage routing decisions in an out of coverage scenario.

It should be understood that UEs in an out of coverage scenario or UEs in a relay scenario may communicate via broadcast, groupcast, or unicast. For example, with broadcast, one signal is sent from one UE to many other UEs, may include blind retransmission of the signal, and may have a predefined destination ID per service. As another example, with groupcast, a signal may be sent to a specific group of UEs each identified by a group ID, may include an ACK/NACK retransmission, and a destination ID may be identified through an application server or preconfigured in each of the UEs. As yet another example, with unicast, an L2 link between two UEs may be established and maintained, may include an ACK/NACK retransmission, and a destination ID may be identified through an application server, a discovery procedure, or preconfigured in each of the UEs.

Precoding may include beamforming to support multi-stream (or multi-layer) transmission in multi-antenna wireless communications. In some aspects, for single-stream beamforming, a same signal may be emitted from each of the transmit antennas with appropriate weighting (e.g., phase and gain) such that the signal power is maximized at the receiver output. When the receiver has multiple antennas, single-stream beamforming may not simultaneously maximize the signal level at all of the receive antennas. In order to maximize the throughput in multiple receive antenna systems, multi-stream transmission may be used. In point-to-point systems, precoding may include multiple data streams that are emitted from transmit antennas with independent and appropriate weightings such that an link throughput is maximized at the receiver output. In multi-user MIMO, the data streams may be intended for different users and some measure of the total throughput may be maximized. Precoding is a technique that may use transmit diversity by weighting the information stream. For example, precoding may include a situation where the transmitter sends the coded information to the receiver to achieve pre-knowledge of the channel. The receiver may be a simple detector, such as a matched filter, and may not have to know the channel state information. This technique may reduce the corrupted effect of the communication channel. Iterative precoding may include a technique where transmitters and receivers repeatedly share coded information (e.g., precoders) to continually maintain pre-knowledge of one or more channels. For example, as described herein transmitters and receivers may implement iterative precoding or may iteratively use precoders by using channel state feedback (CSF) parameters to continually maintain pre-knowledge of one or more channels. A precoder may be used to align the vector containing the transmit symbols with the eigenvector(s) of a channel. In other words, a precoder may be used to transform transmit symbols vector in such a way that the vector reaches the receiver in the strongest form that is possible in the given channel. A precoder may include information used to minimize the error in a receiver output.

In some aspects, relays may utilize one or more same resources and form a virtual super node with a combined total number of transmit antennas as beamformers. In order to achieve strong or optimal performance, coordination and cooperation between relay nodes may be utilized. Improvements to non-codebook-based beamforming and codebook-based beamforming may be used among two or more network entities (e.g., two or more UEs such as a first UE (UE1) and a second UE (UE2)) by assuming iterative sharing of channel state feedback (CSF) parameters or computations among the two or more network entities. The improvements to non-codebook-based beamforming and codebook-based beamforming may be applied to both sidelink (SL, PC5) relaying and uplink (UL) coverage (Uu) relaying.

In some aspects, a first UE and a second UE may each have a quantity of transmit antennas, for example, as same quantity of transmit antennas. The first UE and the second UE together may be equivalent to a single UE with the twice the quantity of transmit antennas as either the first UE or the second UE alone. Thus, when both the first UE and the second UE know the best precoders among both the first UE and the second UE, the combination of the first UE and the second UE may form a super node of transmit antennas for beamforming. In order to obtain the best precoders, a first UE may determine one or more channel state feedback (CSF) parameters of one or more beams associated with the first UE. The UE may select one or more beam coefficients (in the case of non-codebook-based beamforming) (or may select a beam indices (in this case of codebook-based beamforming)) based on the one or more CSF parameters and transmit the beam coefficients to the second UE. The second UE may receive the one or more beam coefficients from the first UE and select one or more beams for beamforming based on the one or more beam coefficients. The second UE may then determine one or more CSF parameters of the one or more beams associated with the second UE and transmit the one or more CSF parameters determined by the second UE to the first UE. The first UE may then receive the one or more CSF parameters from the second UE and select one or more new beam coefficients based on at least the one or more CSF parameters from the second UE.

In some aspects, the first UE may select one or more new beam coefficients based on the one or more CSF parameter from the second UE and the one or more beam coefficients previously selected by the first UE. The first UE may select the new beam coefficients associated with the best beams between the first UE and the second UE to create a super node (e.g., a virtual UE) for beamforming between the first UE and the second UE. These beams may be used for improved sidelink communication and uplink communication. The first UE may select one or more precoders associated with the one or more beam coefficients based on the one or more CSF parameters when selecting the one or more beam coefficients based on the one or more CSF parameters. A precoder may be used to transform transmit symbols vector in such a way that the vector reaches the receiver in the strongest form that is possible in the given channel. In some aspects, the first UE may be a receiving UE and the second UE may be transmitting UE such that the second UE may subsequently send a transmission to the first UE based on a selection of the best beams determined by the first UE. The best beams may be the beams with the highest performance, such as the highest modulation and coding scheme (MCS) values, signal to noise ratio (SINR) values, or the like. In some aspects, these steps may be repeated multiple time amongst the first UE and the second UE in order to continuously determine the best beams between the first UE and the second UE and create a super node for beamforming. In some aspects, these steps may be expanded to a plurality of UEs and repeated one or more times in order to continuously determine the best beams between the plurality of UEs and create super nodes amongst the plurality of UEs for beamforming. In some aspects, the shared indices or beam coefficients may each include an indication of the source (e.g., the first UE) so that each of the plurality of UEs may associate a particular received indices or beam coefficient with a particular UE of the plurality of UEs.

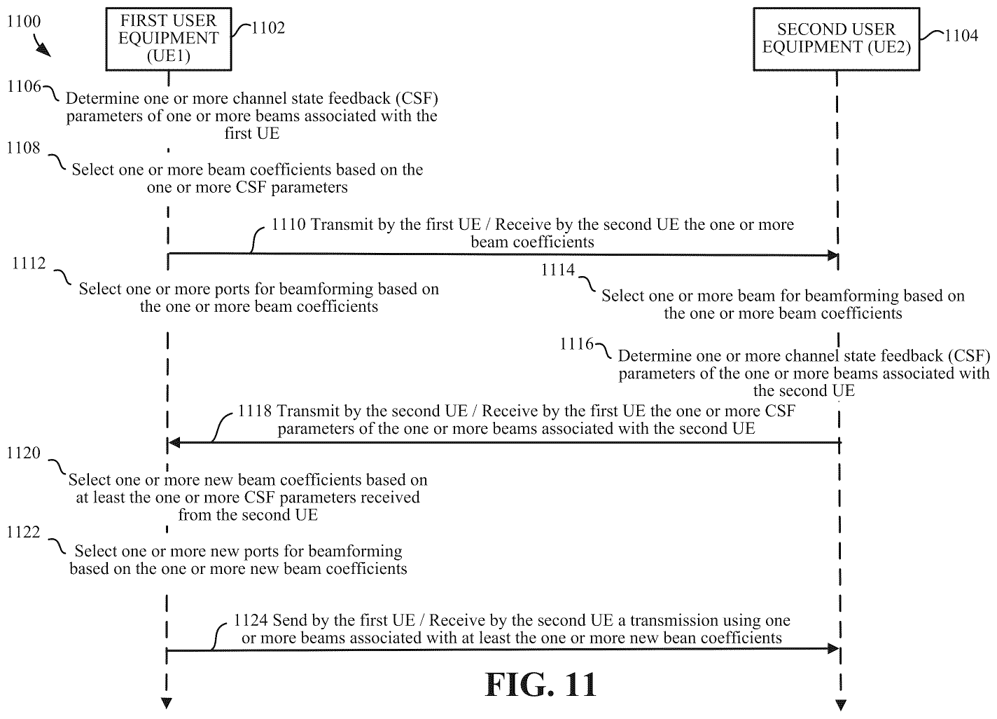

FIG. 11 is another conceptual signaling diagram illustrating an example environment 1100 for iterative precoders computation and coordination for sidelink and uplink coverages according to some aspects. In the example shown in FIG. 11, a first user equipment (UE1) 1102 is in wireless communication with a second UE (UE2) 1104 over one or more wireless communication links. In some aspects, the UE1 1102 may be in wireless communication with the UE2 1104. In some aspects, the UE1 1102 may be capable of determining CSF parameters at a quicker rate compared to the UE2 1104. In some aspects, the UE1 1102 may be more available than the UE2 1104. It should be understood that the UE1 1102 and the UE2 1104 are examples of network entities and are thus not limited to user equipment. In some aspects, the UE1 1102 may be a receiving UE and the UE2 1104 may be transmitting UE such that the UE2 1104 may send a transmission to the UE1 1102 based on a selection of beams determined by the UE1 1102. For example, each of the UE1 1102 and the UE2 1104 may correspond to any of the entities, gNodeBs, UEs, or the like as shown in FIGS. 1-5, 9, 10A, 10B, and 10C.

At 1106, the UE1 1102 may determine one or more channel state feedback (CSF) parameters of one or more beams associated with the UE1 1102. In some aspects, the one or more CSF parameters are codebook based and include a report that includes at least one of precoding matrix indicator (PMI), channel quality information (CQI), rank indication (RI), reference signal received power (RSRP), or an indication of at least one wideband (WB) beam. In some aspects, the one or more CSF parameters comprise one or more quantized versions of beams. Quantized versions of beam may be used with more generic beamforming such as singular value decomposition (SVD). Because the dimensions are not high since UEs are generally equipped with a low number of transceiver antennas (e.g., 4 transceiver antennas), generic beamforming may be easily utilized by the first UE and the second UE. At 1108, the UE1 1102 may select one or more beam coefficients based on the one or more CSF parameters. In some aspects, the one or more beam coefficients may include average covariance matrices of one or more channels. In some aspects, the first UE may select one or more precoders associated with the one or more beam coefficients based on the one or more CSF parameters when selecting the one or more beam coefficients based on the one or more CSF parameters. A precoder may be used to transform transmit symbols vector in such a way that the vector reaches the receiver in the strongest form that is possible in the given channel. At 1110, the UE1 1102 may transmit the one or more beam coefficients to the UE2 1104. In some aspects, the one or more beam coefficients transmitted by the UE1 1102 to at least the UE2 1104 may include an identity of the UE1 1102. In some aspects, the UE2 1104 may be the receiving UE at a hop for relay transmission. In some aspects, the UE1 1102 may transmit the one or more beam coefficients to a plurality of UEs at a hop including the UE2 1104 so that each of the plurality of UEs at the hop may perform the functions described herein with respect to the UE2 1104.

At 1112, the UE1 1102 may select one or more ports for beamforming based on the one or more beam coefficients. In some aspects, port selection may use precoded CSI-RS with known underlying beams and coefficients. At 1114, the UE2 1104 may select one or more beams for beamforming based on the one or more beam coefficients. For example, the UE2 1104 may receive the one or more beam coefficients from the UE1 1102 and select one or more beams for beamforming based on the one or more beam coefficients received from the UE1 1102. In some aspects, the beams selected for beamforming by the UE2 1104 may be used for transmitting a transmission received from the UE1 1102 to another UE or a base station.

At 1116, the UE2 1104 may determine one or more CSF parameters for the one or more beams associated with the UE2 1104. In some aspects, the one or more CSF parameters may include at least one of one or more transmission configuration indicators (TCI) state or one or more analog beamformers. In some aspects, the UE2 1104 may determine one or more precoders associated with the one or more CSF parameters. A precoder may be used to transform transmit symbols vector in such a way that the vector reaches the receiver in the strongest form that is possible in the given channel. In some aspects, the one or more CSF parameters may be codebook based and may include a report that includes at least one of precoding matrix indicator (PMI), channel quality information (CQI), rank indication (RI), reference signal received power (RSRP), or an indication of at least one wideband (WB) beam. In some aspects, the one or more CSF parameters comprise one or more quantized versions of beams.

At 1118, the UE2 1104 may transmit the one or more CSF parameters of the one or more beam associated with the UE2 1104 to the UE1 1102. In some aspects, the one or more additional CSF parameters comprise at least one of one or more transmission configuration indicators (TCI) state or one or more analog beamformers. In some aspects, the UE2 1104 may transmit one or more precoders associated with the one or more CSF parameters to the UE1 1102 when transmitting the one more CFS parameters. At 1120, the UE1 1102 may select one or more new beam coefficients based on at least the one or more CSF parameters received from the UE2 1104. In some aspects, the UE1 1102 may select the one or more new beam coefficients based on the one or more CSF parameters. In some aspects, the UE1 1102 and/or the UE2 1104 may store the CSF parameters and/or the beam coefficients for quick reporting and computation to one or more UEs at a future time and across different iterations. At 1122, the UE1 1102 may select one or more new ports for beamforming based on the one or more new beam coefficients.

At 1124, the UE1 1102 may transmit (or send) a transmission using one or more beams associated with at least the one or more new beam coefficients to at least the UE2 1104. For example, the UE1 may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The UE1 1102 may transmit a transmission using a best one or more beams of the one or more beams to at least the UE2 1104.

In some aspects, one or more additional UEs, including a third UE (UE3), may perform the same or similar operations as the UE2 1104. For example, the UE3 may also transmit one or more CSF parameters of one or more beams associated with the UE3 to the UE1 1102. The UE1 1102 may select one or more new beam coefficients based on at least the one or more CSF parameters received from the UE2 1104 and the one or more CSF parameters received from the UE3. In some aspects, the UE1 1102, the UE2 1104, and the UE3 may store the CSF parameters and/or the beam coefficients for quick reporting and computation to one or more UEs at a future time and across different iterations. The UE1 1102 may also select one or more new ports for beamforming based on the one or more new beam coefficients. Subsequently, the UE1 1102 may transmit (or send) a transmission using one or more beams associated with at least the one or more new beam coefficients to at least the UE2 1104 and the UE3. For example, the UE1 1102 may determine that a first beam associated with the UE2 1104 is a best beam and a second beam associated with the UE3 is another best beam. The UE1 1102 may transmit a transmission to the UE2 1104 through the first beam and to the UE3 through the second beam. In this way, the UE2 1104 and the UE3 may be a virtual super-node for beamforming with the UE1 1102.

In some aspects, at least one of the UE1 1102 or the UE2 1104 (or the UE3) may receive a control signal via at least one of radio resource control (RRC) signaling, medium access control (MAC) control element (MAC-CE) signal, sidelink control information (SCI), or downlink control information (DCI). The control signal may indicate a number of times that the UE1 1102 or the UE2 1104 repeats one or more of the steps described herein. In some aspects, the UE1 1102 and/or the UE2 1104 may receive the control signal from a scheduling entity. In some aspects, after transmitting the one or more beam coefficients to at least the UE2 1104, at least one of the UE1 1102 or the UE2 1104 may repeat one or more the steps described herein based on the received control signal. For example, UE1 1102 may repeat the steps of determining one or more channel state feedback (CSF) parameters of one or more beams associated with the first network entity, selecting one or more beam coefficients based on the one or more CSF parameters, transmitting the one or more beam coefficients to at least the second network entity, receiving one or more additional CSF parameters from the second network entity in response to transmitting the one or more beam coefficients to at least the second network entity, selecting one or more new beam coefficients based on at least the one or more additional CSF parameters, and sending a transmission using one or more beams associated with at least the one or more new beam coefficients to at least the second network entity. As another example, the UE2 1104 may repeat the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, transmitting the one or more CSF parameters to the UE1 1102, and receive a transmission using one or more beams associated with the one or more CSF parameters from the UE1 1102. As anther example, at least one of the UE1 1102 or the UE2 1104 may repeat one or more of steps 1106, 1108, 1110, 1112, 1114, 1116, 1118, 1120, or 1122 described herein. In some aspects, in addition to or as alternative to indicating a number of times that the UE1 1102 or the UE2 1104 repeats the one or more steps described herein, the control signal may indicate which one or more steps described herein are to be repeated.

In some aspects, the UE1 1102 may be a receiving UE and the UE2 1104 may be transmitting UE such that the UE2 1104 may subsequently send a transmission to the UE1 1102 based on a selection of the best beams determined by the UE1 1102. The best beams may be the beams with the highest performance, such as the highest modulation and coding scheme (MCS) values, signal to noise ratio (SINR) values, or the like. As described herein, these steps may be repeated multiple time amongst the UE1 1102 and the UE2 1104 in order to continuously determine the best beams between the UE1 1102 and the UE2 1104 and create a super node for beamforming. In some aspects, these steps may be expanded to a plurality of UEs and repeated one or more times in order to continuously determine the best beams between the plurality of UEs and create super nodes amongst the plurality of UEs for beamforming. In some aspects, the shared indices or beam coefficients may each include an indication of the source (e.g., the UE1 1102) so that each of the plurality of UEs may associate a particular received indices or beam coefficient with a particular UE of the plurality of UEs.

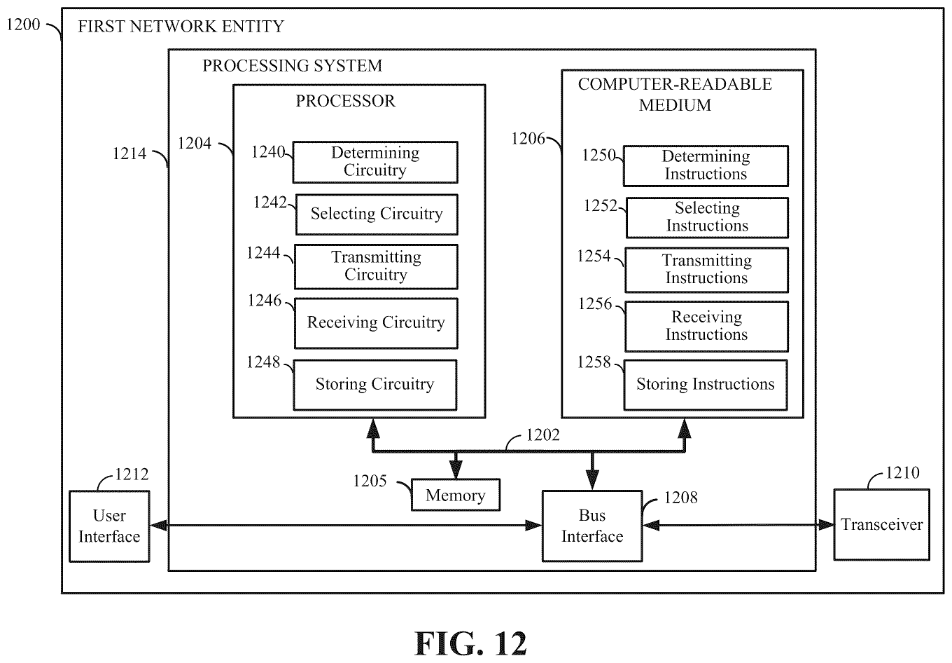

FIG. 12 is a block diagram illustrating an example of a hardware implementation for a first network entity 1200 (e.g., a first user equipment (UE1)) employing a processing system 1214. For example, the first network entity 1200 may be any of the user equipment (UEs) (e.g., a first UE) or base stations (e.g., gNB or eNB) illustrated in any one or more of FIGS. 1-5, 9, 10A, 10B, 10C, and 12.

The first network entity may be implemented with a processing system 1214 that includes one or more processors 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the first network entity 1200 may be configured to perform any one or more of the functions described herein. That is, the processor 1204, as utilized in the first network entity 1200, may be used to implement any one or more of the processes described herein. The processor 1204 may in some instances be implemented via a baseband or modem chip and in other implementations, the processor 1204 may itself comprise a number of devices distinct and different from a baseband or modem chip (e.g., in such scenarios is may work in concert to achieve aspects discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 communicatively couples together various circuits including one or more processors (represented generally by the processor 1204), and computer-readable media (represented generally by the computer-readable storage medium 1206). The bus 1202 may also link various other circuits such as timing sources, peripherals, voltage regulators, and power management circuits, which are well known in the art, and therefore, will not be described any further. A bus interface 1208 provides an interface between the bus 1202 and a transceiver 1210. The transceiver 1210 provides a means for communicating with various other apparatus over a transmission medium (e.g., air interface). A user interface 1212 (e.g., keypad, display, speaker, microphone, joystick) may also be provided.

The processor 1204 is responsible for managing the bus 1202 and general processing, including the execution of software stored on the computer-readable storage medium 1206. The software, when executed by the processor 1204, causes the processing system 1214 to perform the various functions described herein for any particular apparatus. The computer-readable storage medium 1206 may also be used for storing data that is manipulated by the processor 1204 when executing software.

One or more processors 1204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 1206.

The computer-readable storage medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 1206 may reside in the processing system 1214, external to the processing system 1214, or distributed across multiple entities including the processing system 1214. The computer-readable storage medium 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1204 may include circuitry configured for various functions. For example, the processor 1204 may include determining circuitry 1240 configured to determine one or more channel state feedback (CSF) parameters of one or more beams associated with the first network entity. The determining circuitry 1240 may be configured to execute determining instructions 1250 stored in the computer-readable storage medium 1206 to implement any of the one or more of the functions described herein.

The processor 1204 may also include selecting circuitry 1242 configured to select one or more beam coefficients based on the one or more CSF parameters. The selecting circuitry 1242 may also be configured to select one or more ports for beamforming based on the one or more beam coefficients. The selecting circuitry 1242 may be further configured to select one or more new beam coefficients based on at least the one or more additional CSF parameters. In addition, the selecting circuitry 1242 may be configured to select one or more new ports for beamforming based on the one or more new beam coefficients. The selecting circuitry 1242 may be configured to execute selecting instructions 1252 stored in the computer-readable storage medium 1206 to implement any of the one or more of the functions described herein.

The processor 1204 may further include transmitting circuitry 1244 configured to transmit the one or more beam coefficients to at least a second network entity. The transmitting circuitry 1244 may also be configured to transmit the one or more beam coefficients to at least a third network entity after transmitting the one or more beam coefficients to at least the second network entity. The transmitting circuitry 1244 may further be configured to transmit (or send) a transmission using one or more beams associated with at least the one or more new beam coefficients to at least the second network entity. The transmitting circuitry 1244 may be configured to execute transmitting instructions 1254 stored in the computer-readable storage medium 1206 to implement any of the one or more of the functions described herein.

In addition, the processor 1204 may include receiving circuitry 1246 configured to receive one or more additional CSF parameters from the second network entity in response to transmitting the one or more beam coefficients to at least the second network entity. The receiving circuitry 1246 may also be configured to receive a control signal via at least one of radio resource control (RRC) signaling, medium access control (MAC) control element (MAC-CE) signal, sidelink control information (SCI), or downlink control information (DCI). The receiving circuitry 1246 may be configured to execute receiving instructions 1256 stored in the computer-readable storage medium 1206 to implement any of the one or more of the functions described herein.

The processor 1204 may include storing circuitry 1248 configured to store the selected one or more beam coefficients. The storing circuitry 1248 may be configured to execute storing instructions 1258 stored in the computer-readable storage medium 1206 to implement any of the one or more of the functions described herein.

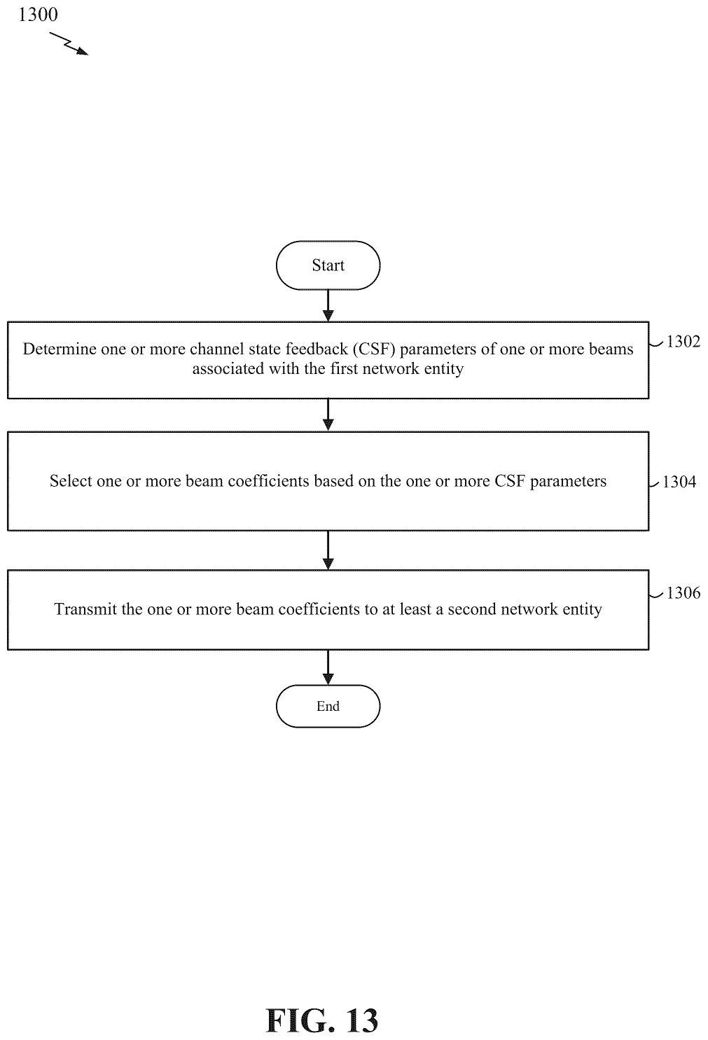

FIG. 13 is a flow chart 1300 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the first network entity 1200, as described herein, and illustrated in FIG. 12, by a processor or processing system, or by any suitable means for carrying out the described functions.

At block 1302, the first network entity 1200 may determine one or more channel state feedback (CSF) parameters of one or more beams associated with the first network entity 1200. For example, the one or more CSF parameters may be codebook based and include a report that includes at least one of precoding matrix indicator (PMI), channel quality information (CQI), rank indication (RI), reference signal received power (RSRP), or an indication of at least one wideband (WB) beam. In some aspects, the one or more CSF parameters may include one or more quantized versions of beams. Quantized versions of beam may be used with more generic beamforming such as singular value decomposition (SVD). Because the dimensions are not high since UEs are generally equipped with a low number of transceiver antennas (e.g., 4 transceiver antennas), generic beamforming may be easily utilized by the first UE and the second UE. The determining circuitry 1240 shown and described above in connection with FIG. 12 may provide a means to determine one or more channel state feedback (CSF) parameters of one or more beams associated with the first network entity 1200.

At block 1304, the first network entity 1200 may select one or more beam coefficients based on the one or more CSF parameters. In some aspects, the one or more beam coefficients may include average covariance matrices of one or more channels. In some aspects, the first network entity 1200 may select one or more precoders associated with the one or more beam coefficients based on the one or more CSF parameters when selecting the one or more beam coefficients based on the one or more CSF parameters. A precoder may be used to transform transmit symbols vector in such a way that the vector reaches the receiver in the strongest form that is possible in the given channel. The selecting circuitry 1242, shown and described above in connection with FIG. 12 may provide a means to select one or more beam coefficients based on the one or more CSF parameters.

At block 1306, the first network entity 1200 may transmit the one or more beam coefficients to at least a second network entity. In some aspects, the one or more beam coefficients transmitted by the first network entity 1200 to at least a second network entity may include an identity of the first network entity 1200. In some aspects, the second network entity may be the receiving UE at a hop for relay transmission. In some aspects, the first network entity 1200 may transmit the one or more beam coefficients to a plurality of network entities at a hop including the second network entity so that each of the plurality of network entities at the hop may perform the functions described herein with respect to the second network entity. The transmitting circuitry 1244 together with the transceiver 1210, shown and described above in connection with FIG. 12 may provide a means to transmit the one or more beam coefficients to at least a second network entity.

In some aspects, the first network entity 1200 may select one or more ports for beamforming based on the one or more beam coefficients. In some aspects, port selection may use precoded CSI-RS with known underlying beams and coefficients. The second network entity may select one or more beams for beamforming based on the one or more beam coefficients received from the first network entity 1200. For example, the second network entity may receive the one or more beam coefficients from the first network entity 1200 and select one or more beams for beamforming based on the one or more beam coefficients received from the first network entity 1200. In some aspects, the beams selected for beamforming by the second network entity may be used for transmitting a transmission received from the first network entity 1200 to another UE or a base station.

The second network entity may determine one or more CSF parameters for the one or more beams associated with the second network entity. In some aspects, the one or more CSF parameters may include at least one of one or more transmission configuration indicators (TCI) state or one or more analog beamformers. In some aspects, the one or more CSF parameters may be codebook based and may include a report that includes at least one of precoding matrix indicator (PMI), channel quality information (CQI), rank indication (RI), reference signal received power (RSRP), or an indication of at least one wideband (WB) beam. In some aspects, the one or more CSF parameters comprise one or more quantized versions of beams.

In some aspects, the first network entity 1200 may receive the one or more CSF parameters of the one or more beam associated with the second network entity from the second network entity. In some aspects, the one or more additional CSF parameters comprise at least one of one or more transmission configuration indicators (TCI) state or one or more analog beamformers. The first network entity 1200 may select one or more new beam coefficients based on at least the one or more CSF parameters received from the second network entity. In some aspects, the first network entity 1200 may select the one or more new beam coefficients based on the one or more CSF parameters. In some aspects, the first network entity 1200 and/or the second network entity may store the CSF parameters and/or the beam coefficients for quick reporting and computation to one or more network entities at a future time and across different iterations.

In some aspects, the first network entity 1200 may transmit (or send) a transmission using one or more beams associated with at least the one or more new beam coefficients to at least the second network entity. For example, the first network entity 1200 may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The first network entity 1200 may transmit a transmission using a best one or more beams of the one or more beams to at least the second network entity.

In some aspects, one or more additional network entities, including a third network entity, may perform the same or similar operations as the second network entity. For example, the third network entity may also transmit one or more CSF parameters of one or more beams associated with the third network entity to the first network entity. The first network entity 1200 may select one or more new beam coefficients based on at least the one or more CSF parameters received from the second network entity and the one or more CSF parameters received from the third network entity. In some aspects, the first network entity 1200, the second network entity, and the third network entity may store the CSF parameters and/or the beam coefficients for quick reporting and computation to one or more UEs at a future time and across different iterations. The first network entity 1200 may also select one or more new ports for beamforming based on the one or more new beam coefficients. Subsequently, the first network entity 1200 may transmit (or send) a transmission using one or more beams associated with at least the one or more new beam coefficients to at least the second network entity and the third network entity. For example, the first network entity 1200 may determine that a first beam associated with the second network entity is a best beam and a second beam associated with the third network entity is another best beam. The first network entity 1200 may transmit a transmission to the second network entity through the first beam and to the third network entity through the second beam. In this way, the second network entity and the third network entity may be a virtual super-node for beamforming with the first network entity 1200.

The first network entity 1200 may select one or more new ports for beamforming based on the one or more new beam coefficients. In some aspects, at least one of the first network entity 1200 or the second network entity may receive a control signal via at least one of radio resource control (RRC) signaling, medium access control (MAC) control element (MAC-CE) signal, sidelink control information (SCI), or downlink control information (DCI). The control signal may indicate a number of times that the first network entity 1200 and/or the second network entity repeats one or more of the steps described herein. In some aspects, the first network entity 1200 and/or the second network entity may receive the control signal from a scheduling entity. In some aspects, after transmitting the one or more beam coefficients to at least the second network entity, at least one of the first network entity 1200 or the second network entity may repeat one or more the steps described herein based on the received control signal. For example, first network entity 1200 may repeat the steps of determining one or more channel state feedback (CSF) parameters of one or more beams associated with the first network entity, selecting one or more beam coefficients based on the one or more CSF parameters, and transmitting the one or more beam coefficients to at least the second network entity. As another example, the second network entity may repeat the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, and transmitting the one or more CSF parameters to the first network entity. In some aspects, in addition to or as alternative to indicating a number of times that the first network entity 1200 and/or the second network entity repeats the one or more steps described herein, the control signal may indicate which one or more steps described herein are to be repeated.

In some aspects, the first network entity 1200 may be a receiving UE and the second network entity may be transmitting UE such that the second network entity may subsequently send a transmission to the first network entity based on a selection of the best beams determined by the first network entity 1200 and/or the second network entity. The best beams may be the beams with the highest performance, such as the highest modulation and coding scheme (MCS) values, signal to noise ratio (SINR) values, or the like. As described herein, these steps may be repeated multiple time amongst the first network entity 1200 and/or the second network entity in order to continuously determine the best beams between the first network entity 1200 and/or the second network entity and create a super node for beamforming. In some aspects, these steps may be expanded to a plurality of network entities and repeated one or more times in order to continuously determine the best beams between the plurality of network entity and create super nodes amongst the plurality of network for beamforming and relaying. In some aspects, the shared indices or beam coefficients may each include an indication of the source (e.g., the first network entity) so that each of the plurality of network entities may associate a particular received indices or beam coefficient with a particular network entity of the plurality of network entities.

In one configuration, the first network entity 1200 includes means for performing the various functions and processes described in relation to FIG. 13. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-5, 9, 10A, 10B, 10C, 11, and 12 and utilizing, for example, the processes and/or algorithms described herein in relation to FIG. 13.

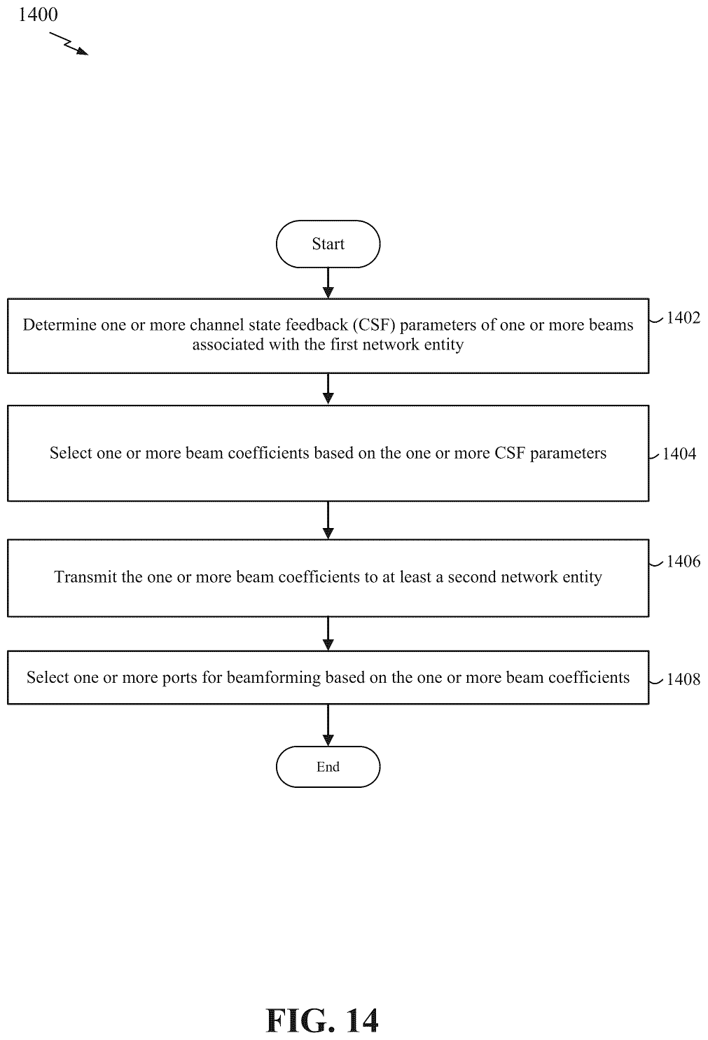

FIG. 14 is a flow chart 1400 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the first network entity 1200, as described herein, and illustrated in FIG. 12, by a processor or processing system, or by any suitable means for carrying out the described functions.

At block 1402, the first network entity 1200 may determine one or more channel state feedback (CSF) parameters of one or more beams associated with the first network entity 1200. Block 1402 includes the same or similar features described herein at least with respect to block 1302. At block 1404, the first network entity 1200 may select one or more beam coefficients based on the one or more CSF parameters. Block 1404 includes the same or similar features described herein at least with respect to block 1304. At block 1406, the first network entity 1200 may transmit the one or more beam coefficients to at least a second network entity. Block 1406 includes the same or similar features described herein at least with respect to block 1306.

At block 1408, the first network entity 1200 may select one or more ports for beamforming based on the one or more beam coefficients. In some aspects, port selection may use precoded CSI-RS with known underlying beams and coefficients. The selecting circuitry 1242, shown and described above in connection with FIG. 12 may provide a means to select one or more ports for beamforming based on the one or more beam coefficients.

In one configuration, the first network entity 1200 includes means for performing the various functions and processes described in relation to FIG. 14. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-5, 9, 10A, 10B, 10C, 11, and 12 and utilizing, for example, the processes and/or algorithms described herein in relation to FIG. 14.

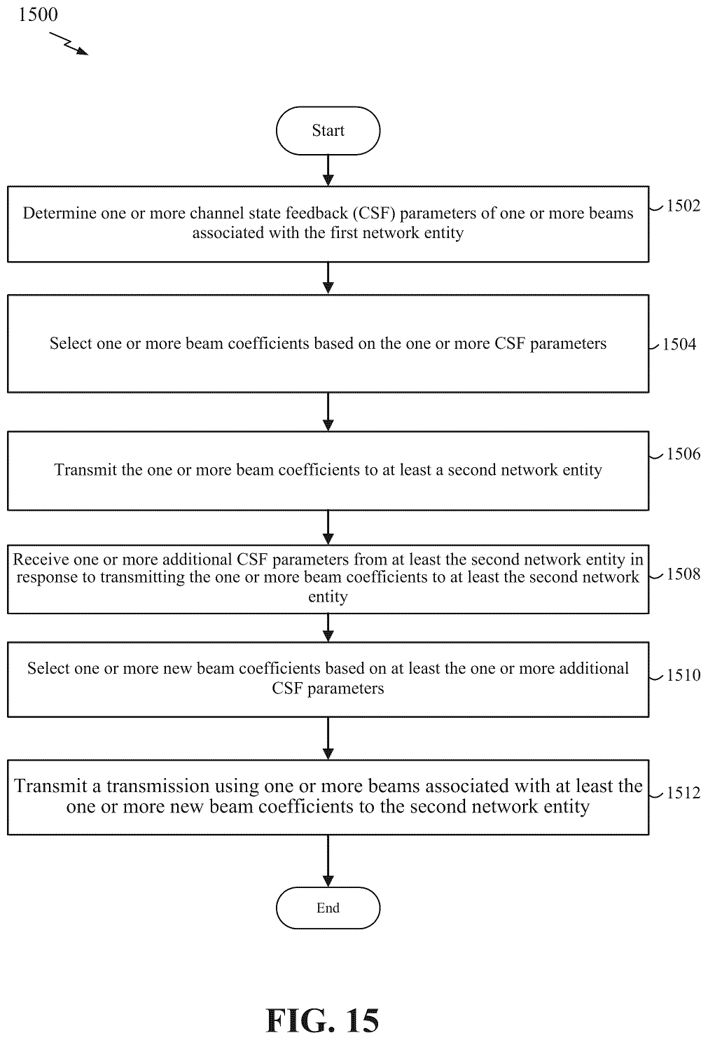

FIG. 15 is a flow chart 1500 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the first network entity 1200, as described herein, and illustrated in FIG. 12, by a processor or processing system, or by any suitable means for carrying out the described functions.

At block 1502, the first network entity 1200 may determine one or more channel state feedback (CSF) parameters of one or more beams associated with the first network entity 1200. Block 1502 includes the same or similar features described herein at least with respect to block 1302. At block 1504, the first network entity 1200 may select one or more beam coefficients based on the one or more CSF parameters. Block 1504 includes the same or similar features described herein at least with respect to block 1304. At block 1506, the first network entity 1200 may transmit the one or more beam coefficients to at least a second network entity. Block 1506 includes the same or similar features described herein at least with respect to block 1306.

At block 1508, the first network entity 1200 may receive one or more additional CSF parameters from at least the second network entity in response to transmitting the one or more beam coefficients to at least the second network entity. In some aspects, the one or more additional CSF parameters comprise at least one of one or more transmission configuration indicators (TCI) state or one or more analog beamformers. The receiving circuitry 1246, shown and described above in connection with FIG. 12 may provide a means to receive one or more additional CSF parameters from at least the second network entity in response to transmitting the one or more beam coefficients to at least the second network entity.

At block 1510, the first network entity 1200 may select one or more new beam coefficients based on at least the one or more additional CSF parameters. The selecting circuitry 1242, shown and described above in connection with FIG. 12 may provide a means to select one or more new beam coefficients based on at least the one or more additional CSF parameters.

At block 1512, the first network entity 1200 may transmit (or send) a transmission using one or more beams associated with at least the one or more new beam coefficients to at least the second network entity. For example, the first network entity 1200 may transmit (or send) a transmission using one or more beams associated with at least the one or more new beam coefficients to at least the second network entity. The first network entity 1200 may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The first network entity 1200 may transmit a transmission using a best one or more beams of the one or more beams to at least the second network entity.

In some aspects, one or more additional network entities, including a third network entity, may perform the same or similar operations as the second network entity. For example, the third network entity may also transmit one or more CSF parameters of one or more beams associated with the third network entity to the first network entity. The first network entity 1200 may select one or more new beam coefficients based on at least the one or more CSF parameters received from the second network entity and the one or more CSF parameters received from the third network entity. In some aspects, the first network entity, the second network entity, and the third network entity may store the CSF parameters and/or the beam coefficients for quick reporting and computation to one or more UEs at a future time and across different iterations. The first network entity 1200 may also select one or more new ports for beamforming based on the one or more new beam coefficients. Subsequently, the first network entity 1200 may transmit (or send) a transmission using one or more beams associated with at least the one or more new beam coefficients to at least the second network entity and the third network entity. For example, the first network entity 1200 may determine that a first beam associated with the second network entity is a best beam and a second beam associated with the third network entity is another best beam. The first network entity 1200 may transmit a transmission to the second network entity through the first beam and to the third network entity through the second beam. In this way, the second network entity and the third network entity may be a virtual super-node for beamforming with the first network entity 1200. The transmitting circuitry 1244, shown and described above in connection with FIG. 12 may provide a means to transmit (or send) a transmission using one or more beams associated with at least the one or more new beam coefficients to at least the second network entity.

In one configuration, the first network entity 1200 includes means for performing the various functions and processes described in relation to FIG. 12. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-5, 9, 10A, 10B, 10C, 11, and 12 and utilizing, for example, the processes and/or algorithms described herein in relation to FIG. 15.

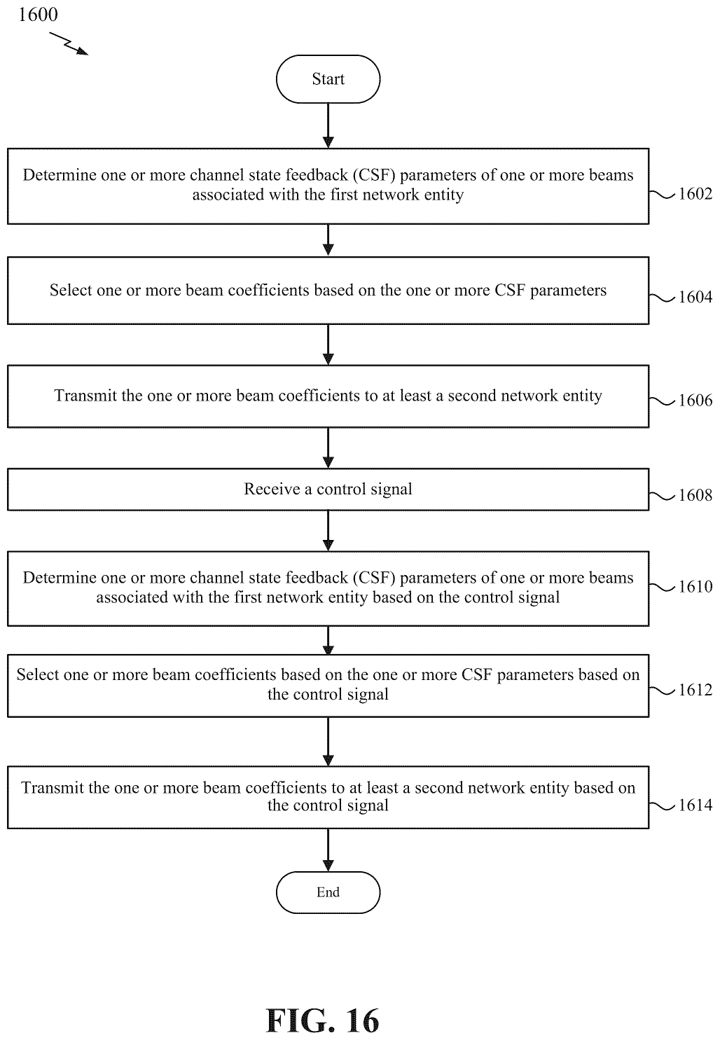

FIG. 16 is a flow chart 1600 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the first network entity 1200, as described herein, and illustrated in FIG. 12, by a processor or processing system, or by any suitable means for carrying out the described functions.

At block 1602, the first network entity 1200 may determine one or more channel state feedback (CSF) parameters of one or more beams associated with the first network entity 1200. Block 1602 includes the same or similar features described herein at least with respect to block 1302. At block 1604, the first network entity 1200 may select one or more beam coefficients based on the one or more CSF parameters. Block 1604 includes the same or similar features described herein at least with respect to block 1304. At block 1606, the first network entity 1200 may transmit the one or more beam coefficients to at least a second network entity. Block 1606 includes the same or similar features described herein at least with respect to block 1306.

At block 1608, the first network entity 1200 may receive a control signal. For example, the first network entity 1200 may receive a control signal via at least one of radio resource control (RRC) signaling, medium access control (MAC) control element (MAC-CE) signal, sidelink control information (SCI), or downlink control information (DCI). The control signal may indicate a number of times that the first network entity 1200 and/or the second network entity repeats one or more of the steps described herein. In some aspects, the first network entity 1200 and/or the second network entity may receive the control signal from a scheduling entity. The receiving circuitry 1246, shown and described above in connection with FIG. 12 may provide a means to receive a control signal.

At block 1610, the first network entity 1200 may determine one or more channel state feedback (CSF) parameters of one or more beams associated with the first network entity 1200 based on the control signal. Block 1610 includes the same or similar features described herein at least with respect to block 1302. The determining circuitry 1240, shown and described above in connection with FIG. 12 may provide a means to determine one or more channel state feedback (CSF) parameters of one or more beams associated with the first network entity 1200 based on the control signal.

At block 1612, the first network entity 1200 may select one or more beam coefficients based on the one or more CSF parameters based on the control signal. Block 1612 includes the same or similar features described herein at least with respect to block 1304. The selecting circuitry 1242, shown and described above in connection with FIG. 12 may provide a means to select one or more beam coefficients based on the one or more CSF parameters based on the control signal.

At block 1614, the first network entity 1200 may transmit the one or more beam coefficients to at least a second network entity based on the control signal. Block 1606 includes the same or similar features described herein at least with respect to block 1306. The transmitting circuitry 1244, shown and described above in connection with FIG. 12 may provide a means to transmit the one or more beam coefficients to at least a second network entity based on the control signal.

In one configuration, the first network entity 1200 includes means for performing the various functions and processes described in relation to FIG. 16. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-5, 9, 10A, 10B, 10C, 11, and 12 and utilizing, for example, the processes and/or algorithms described herein in relation to FIG. 16.

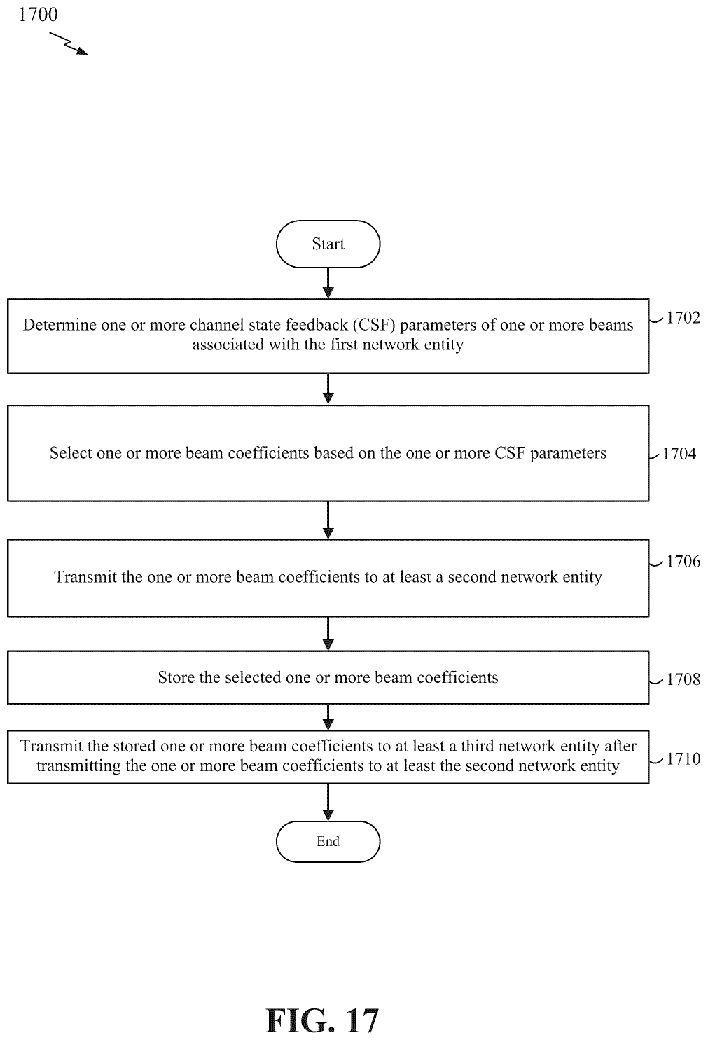

FIG. 17 is a flow chart 1700 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the first network entity 1200, as described herein, and illustrated in FIG. 12, by a processor or processing system, or by any suitable means for carrying out the described functions.

At block 1702, the first network entity 1200 may determine one or more channel state feedback (CSF) parameters of one or more beams associated with the first network entity 1200. Block 1702 includes the same or similar features described herein at least with respect to block 1302. At block 1704, the first network entity 1200 may select one or more beam coefficients based on the one or more CSF parameters. Block 1704 includes the same or similar features described herein at least with respect to block 1304. At block 1706, the first network entity 1200 may transmit the one or more beam coefficients to at least a second network entity. Block 1706 includes the same or similar features described herein at least with respect to block 1306.

At block 1708, the first network entity 1200 may store the selected one or more beam coefficients. In some aspects, the first network entity 1200 and/or the second network entity may store the CSF parameters and/or the beam coefficients for quick reporting and computation to one or more network entities at a future time and across different iterations. In some aspects, the first network entity 1200 may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The first network entity 1200 may store the one or more beam coefficients for later transmission to the third network entity using a best one or more beams of the one or more beams. The storing circuitry 1248, shown and described above in connection with FIG. 12 may provide a means to store the selected one or more beam coefficients.

At block 1710, the first network entity 1200 may transmit the stored one or more beam coefficients to at least a third network entity after transmitting the one or more beam coefficients to at least the second network entity. For example, after transmitting the one or more beams coefficients to the second network entity, the first network entity 1200 may transmit the stored one or more beam coefficients to at least a third network entity. Subsequently, the first network entity 1200 may transmit (or send) a transmission using one or more beams associated with at least the one or more new beam coefficients to at least a third network entity. The transmitting circuitry 1244, shown and described above in connection with FIG. 12 may provide a means to transmit the stored one or more beam coefficients to at least a third network entity after transmitting the one or more beam coefficients to at least the second network entity.

In one configuration, the first network entity 1200 includes means for performing the various functions and processes described in relation to FIG. 17. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1-5, 9, 10A, 10B, 10C, 11, and 12 and utilizing, for example, the processes and/or algorithms described herein in relation to FIG. 17.

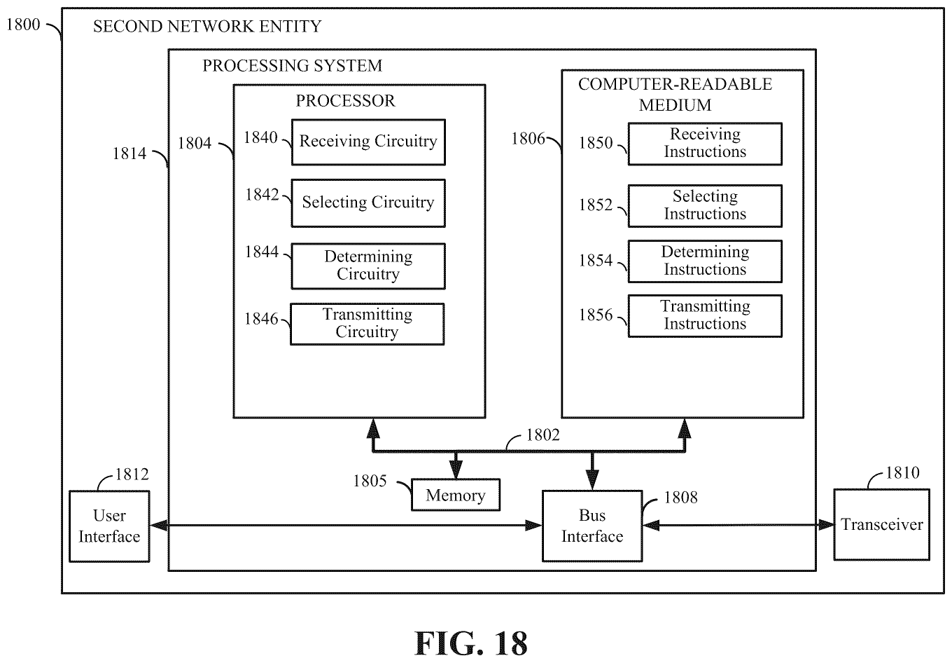

FIG. 18 is a block diagram illustrating an example of a hardware implementation for a second network entity 1800 (e.g., a second UE (UE2)) employing a processing system 1814 according to some aspects. For example, the second network entity 1800 may correspond to any of the devices or systems shown and described herein in any one or more of FIGS. 1-5, 9, 10A, 10B, 10C, 11, and 12.

In accordance with various aspects of the disclosure, an element, or any portion of an element, or any combination of elements may be implemented with a processing system 1814 that includes one or more processors 1804. The processing system 1814 may be substantially the same as the processing system 1214 illustrated in FIG. 12, including a bus interface 1808, a bus 1802, a processor 1804, and a computer-readable storage medium 1806. Furthermore, the second network entity 1800 may include a user interface 1812 and a transceiver 1810 substantially similar to those described above in FIG. 12. That is, the processor 1804, as utilized in the second network entity 1800, may be used to implement any one or more of the processes described herein.

In some aspects of the disclosure, the processor 1804 may include circuitry configured for various functions. For example, the processor 1804 may include receiving circuitry 1840 configured to receive one or more beam coefficients associated with at least a first network entity of one or more network entities. The receiving circuitry 1840 may also be configured to receive a control signal via at least one of radio resource control (RRC) signaling, medium access control (MAC) control element (MAC-CE) signal, sidelink control information (SCI), or downlink control information (DCI). The receiving circuitry 1840 may be further configured to receive a transmission using one or more beams associated with the one or more CSF parameters from the first network entity. The receiving circuitry 1840 may be configured to execute receiving instructions 1850 stored in the computer-readable storage medium 1806 to implement any of the one or more of the functions described herein.

The processor 1804 may also include selecting circuitry 1842 configured to select one or more beams for beamforming based on the one or more beam coefficients. The selecting circuitry 1842 may also be configured to select one or more ports for beamforming based on the one or more beam coefficients. The selecting circuitry 1842 may be configured to execute selecting instructions 1852 stored in the computer-readable storage medium 1806 to implement any of the one or more of the functions described herein.

The processor 1804 may further include determining circuitry 1844 configured to determine one or more channel state feedback (CSF) parameters of the one or more beams associated with the one or more beam coefficients. The determining circuitry 1844 may also be configured to determine one or more channel state feedback (CSF) parameters of the one or more beams associated with the one or more beam coefficients. The determining circuitry 1844 may be configured to execute determining instructions 1854 stored in the computer-readable storage medium 1806 to implement any of the one or more of the functions described herein.

In addition, the processor 1804 may include transmitting circuitry 1846 configured to transmit the one or more CSF parameters to the first network entity. The transmitting circuitry 1846 may also be configured to transmit an indication of the one or more beams for beamforming based on the one or more beam coefficients to at least the first network entity. The transmitting circuitry 1846 may be further configured to transmit the one or more CSF parameters to the first network entity. The transmitting circuitry 1846 may be configured to execute transmitting instructions 1856 stored in the computer-readable storage medium 1806 to implement any of the one or more of the functions described herein.

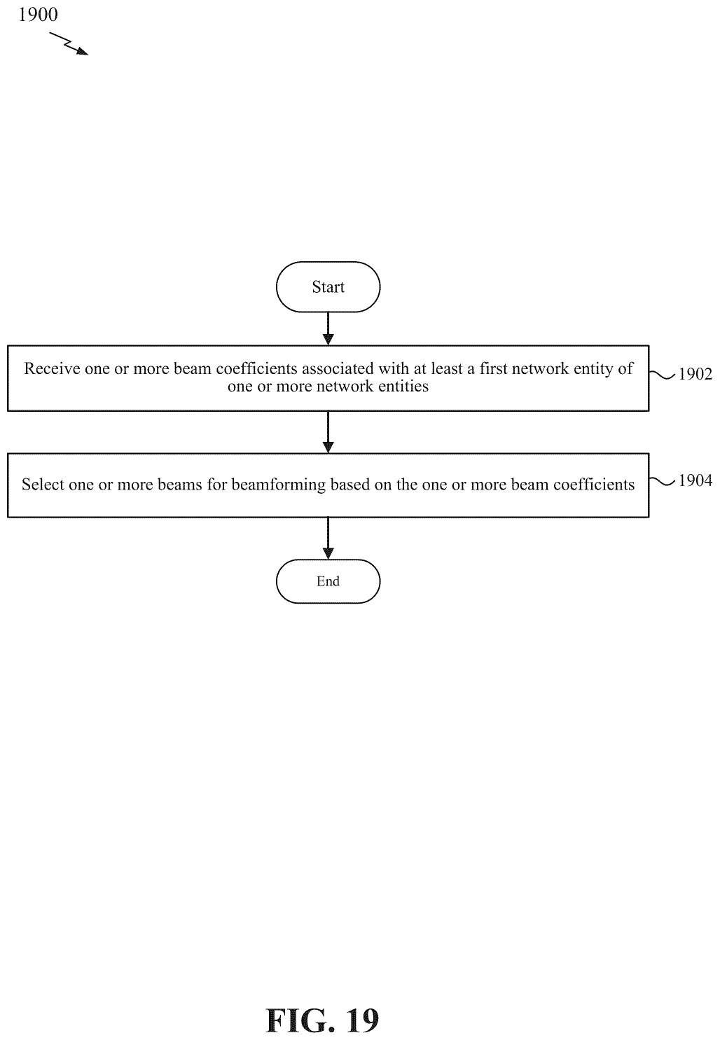

FIG. 19 is a flow chart 1900 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the second network entity 1800, as described herein, and illustrated in FIG. 18, by a processor or processing system, or by any suitable means for carrying out the described functions.

At block 1902, the second network entity 1800 may receive one or more beam coefficients associated with at least a first network entity of one or more network entities. For example, the first network entity may determine one or more channel state feedback (CSF) parameters of one or more beams associated with the first network entity. For example, the one or more CSF parameters may be codebook based and include a report that includes at least one of precoding matrix indicator (PMI), channel quality information (CQI), rank indication (RI), reference signal received power (RSRP), or an indication of at least one wideband (WB) beam. In some aspects, the one or more CSF parameters may include one or more quantized versions of beams. Quantized versions of beam may be used with more generic beamforming such as singular value decomposition (SVD). Because the dimensions are not high since UEs are generally equipped with a low number of transceiver antennas (e.g., 4 transceiver antennas), generic beamforming may be easily utilized by the first UE and the second UE. The first network entity may select one or more beam coefficients based on the one or more CSF parameters. In some aspects, the one or more beam coefficients may include average covariance matrices of one or more channels.

The second network entity 1800 may receive the one or more beam coefficients from the first network entity. In some aspects, the one or more beam coefficients transmitted by the first network entity to at least a second network entity 1800 may include an identity of the first network entity. In some aspects, the second network entity 1800 may receive one or more precoders associated with the one or more beam coefficients from the first network entity when receiving the one or more beam coefficients. A precoder may be used to transform transmit symbols vector in such a way that the vector reaches the receiver in the strongest form that is possible in the given channel. In some aspects, the second network entity 1800 may be the receiving UE at a hop for relay transmission. In some aspects, the first network entity may transmit the one or more beam coefficients to a plurality of network entities at a hop including the second network entity 1800 so that each of the plurality of network entities at the hop may perform the functions described herein with respect to the second network entity 1800. The receiving circuitry 1840 shown and described above in connection with FIG. 18 may provide a means to receive one or more beam coefficients associated with at least a first network entity of one or more network entities.

At block 1904, the second network entity 1800 may select one or more beams for beamforming based on the one or more beam coefficients. For example, the second network entity 1800 may receive the one or more beam coefficients from the first network entity and select one or more beams for beamforming based on the one or more beam coefficients received from the first network entity. In some aspects, the beams selected for beamforming by the second network entity 1800 may be used for transmitting a transmission received from the first network entity to another UE or a base station. The selecting circuitry 1842, shown and described above in connection with FIG. 18 may provide a means to select one or more beam s for beamforming based on the one or more beam coefficients.

The second network entity 1800 may determine one or more CSF parameters for the one or more beams associated with the second network entity 1800. In some aspects, the one or more CSF parameters may include at least one of one or more transmission configuration indicators (TCI) state or one or more analog beamformers. In some aspects, the one or more CSF parameters may be codebook based and may include a report that includes at least one of precoding matrix indicator (PMI), channel quality information (CQI), rank indication (RI), reference signal received power (RSRP), or an indication of at least one wideband (WB) beam. In some aspects, the second network entity 1800 may determine one or more precoders associated with the one or more CSF parameters. A precoder may be used to transform transmit symbols vector in such a way that the vector reaches the receiver in the strongest form that is possible in the given channel. In some aspects, the one or more CSF parameters comprise one or more quantized versions of beams.

In some aspects, the first network entity may receive the one or more CSF parameters of the one or more beam associated with the second network entity 1800 from the second network entity 1800. In some aspects, the one or more additional CSF parameters comprise at least one of one or more transmission configuration indicators (TCI) state or one or more analog beamformers. In some aspects, the first network entity may receive one or more precoders associated with the one or more CSF parameters and from the second network entity 1800 when receiving the one more CFS parameters. The first network entity may select one or more new beam coefficients based on at least the one or more CSF parameters received from the second network entity 1800. In some aspects, the first network entity may select the one or more new beam coefficients based on the one or more CSF parameters. In some aspects, the first network entity and/or the second network entity 1800 may store the CSF parameters and/or the beam coefficients for quick reporting and computation to one or more network entities at a future time and across different iterations.

In some aspects, the first network entity may transmit (or send) a transmission using one or more beams associated with at least the one or more new beam coefficients to at least the second network entity 1800. For example, the first network entity may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The first network entity may transmit a transmission using a best one or more beams of the one or more beams to at least the second network entity 1800.

In some aspects, one or more additional network entities, including a third network entity, may perform the same or similar operations as the second network entity 1800. For example, the third network entity may also transmit one or more CSF parameters of one or more beams associated with the third network entity to the first network entity. The first network entity may select one or more new beam coefficients based on at least the one or more CSF parameters received from the second network entity 1800 and the one or more CSF parameters received from the third network entity. In some aspects, the first network entity, the second network entity 1800, and the third network entity may store the CSF parameters and/or the beam coefficients for quick reporting and computation to one or more UEs at a future time and across different iterations. The first network entity may also select one or more new ports for beamforming based on the one or more new beam coefficients. Subsequently, the first network entity may transmit (or send) a transmission using one or more beams associated with at least the one or more new beam coefficients to at least the second network entity and the third network entity. For example, the first network entity may determine that a first beam associated with the second network entity 1800 is a best beam and a second beam associated with the third network entity is another best beam. The first network entity may transmit a transmission to the second network entity 1800 through the first beam and to the third network entity through the second beam. In this way, the second network entity 1800 and the third network entity may be a virtual super-node for beamforming with the first network entity.

The first network entity may select one or more new ports for beamforming based on the one or more new beam coefficients. In some aspects, at least one of the first network entity or the second network entity 1800 may receive a control signal via at least one of radio resource control (RRC) signaling, medium access control (MAC) control element (MAC-CE) signal, sidelink control information (SCI), or downlink control information (DCI). The control signal may indicate a number of times that the first network entity and/or the second network entity 1800 repeats one or more of the steps described herein. In some aspects, the first network entity and/or the second network entity 1800 may receive the control signal from a scheduling entity. In some aspects, after transmitting the one or more beam coefficients to at least the second network entity 1800, at least one of the first network entity or the second network entity 1800 may repeat one or more the steps described herein based on the received control signal. For example, first network entity may repeat the steps of determining one or more channel state feedback (CSF) parameters of one or more beams associated with the first network entity, selecting one or more beam coefficients based on the one or more CSF parameters, and transmitting the one or more beam coefficients to at least the second network entity 1800. As another example, the second network entity 1800 may repeat the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, and transmitting the one or more CSF parameters to the first network entity. In some aspects, in addition to or as alternative to indicating a number of times that the first network entity and/or the second network entity 1800 repeats the one or more steps described herein, the control signal may indicate which one or more steps described herein are to be repeated.

In some aspects, the first network entity may be a receiving UE and the second network entity 1800 may be transmitting UE such that the second network entity 1800 may subsequently send a transmission to the first network entity based on a selection of the best beams determined by the first network entity and/or the second network entity 1800. The best beams may be the beams with the highest performance, such as the highest modulation and coding scheme (MCS) values, signal to noise ratio (SINR) values, or the like. As described herein, these steps may be repeated multiple time amongst the first network entity and/or the second network entity 1800 in order to continuously determine the best beams between the first network entity and/or the second network entity 1800 and create a super node for beamforming. In some aspects, these steps may be expanded to a plurality of network entities and repeated one or more times in order to continuously determine the best beams between the plurality of network entity and create super nodes amongst the plurality of network for beamforming and relaying. In some aspects, the shared indices or beam coefficients may each include an indication of the source (e.g., the first network entity) so that each of the plurality of network entities may associate a particular received indices or beam coefficient with a particular network entity of the plurality of network entities.

In one configuration, the second network entity 1800 includes means for performing the various functions and processes described in relation to FIG. 16. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-5, 9, 10A, 10B, 10C, 11, 12, and 18 and utilizing, for example, the processes and/or algorithms described herein in relation to FIG. 19.

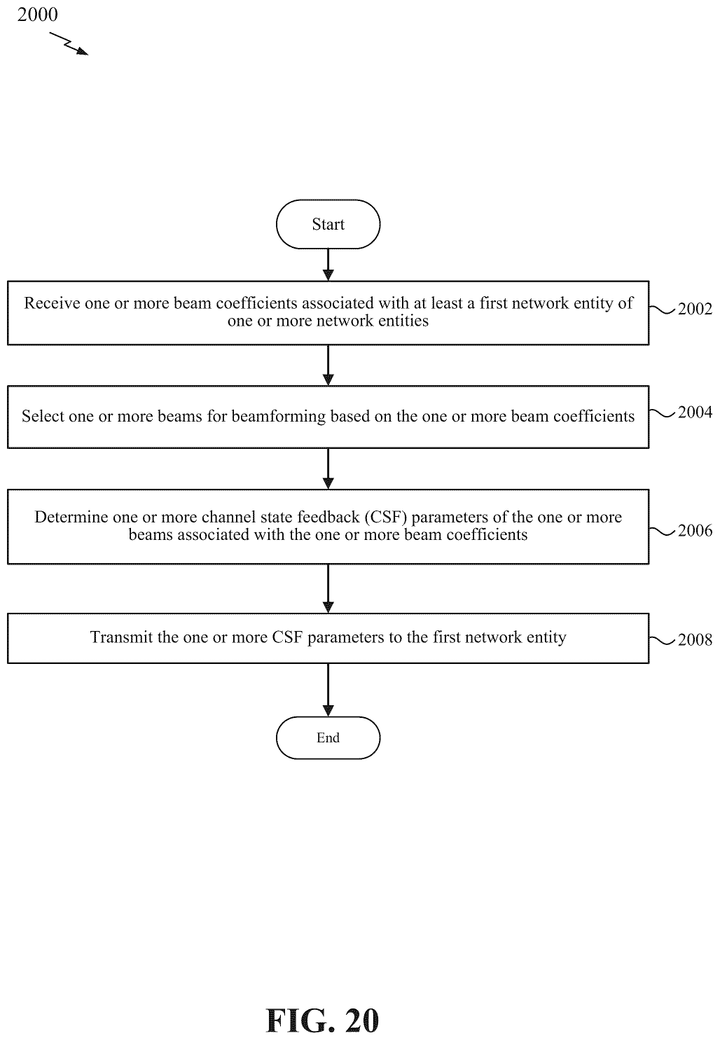

FIG. 20 is a flow chart 2000 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the second network entity 1800, as described herein, and illustrated in FIG. 18, by a processor or processing system, or by any suitable means for carrying out the described functions.

At block 2002, the second network entity 1800 may receive one or more beam coefficients associated with at least a first network entity of one or more network entities. Block 2002 includes the same or similar features described herein at least with respect to block 1902. At block 2004, the second network entity 1800 may select one or more beam s for beamforming based on the one or more beam coefficients. Block 2004 includes the same or similar features described herein at least with respect to block 1904.

At block 2006, the second network entity 1800 may determine one or more channel state feedback (CSF) parameters of the one or more beams associated with the one or more beam coefficients. In some aspects, the one or more CSF parameters may include at least one of one or more transmission configuration indicators (TCI) state or one or more analog beamformers. In some aspects, the one or more CSF parameters may be codebook based and may include a report that includes at least one of precoding matrix indicator (PMI), channel quality information (CQI), rank indication (RI), reference signal received power (RSRP), or an indication of at least one wideband (WB) beam. In some aspects, the second network entity 1800 may determine one or more precoders associated with the one or more CSF parameters. A precoder may be used to transform transmit symbols vector in such a way that the vector reaches the receiver in the strongest form that is possible in the given channel. In some aspects, the one or more CSF parameters comprise one or more quantized versions of beams. The determining circuitry 1844, shown and described above in connection with FIG. 18 may provide a means to determine one or more channel state feedback (CSF) parameters of the one or more beams associated with the one or more beam coefficients.

At block 2008, the second network entity 1800 may transmit the one or more CSF parameters to the first network entity. For example, the second network entity 1800 may transmit the one or more CSF parameters of the one or more beam associated with the second network entity 1800 to the first network entity. In some aspects, the one or more additional CSF parameters comprise at least one of one or more transmission configuration indicators (TCI) state or one or more analog beamformers. The first network entity may select one or more new beam coefficients based on at least the one or more CSF parameters received from the second network entity 1800. In some aspects, the first network entity may select the one or more new beam coefficients based on the one or more CSF parameters. In some aspects, the first network entity may receive one or more precoders associated with the one or more CSF parameters when receiving the one more CFS parameters. In some aspects, the first network entity and/or the second network entity 1800 may store the CSF parameters and/or the beam coefficients for quick reporting and computation to one or more network entities at a future time and across different iterations. The first network entity may select one or more new ports for beamforming based on the one or more new beam coefficients. In some aspects, at least one of the first network entity or the second network entity 1800 may receive a control signal via at least one of radio resource control (RRC) signaling, medium access control (MAC) control element (MAC-CE) signal, sidelink control information (SCI), or downlink control information (DCI). The control signal may indicate a number of times that the first network entity and/or the second network entity 1800 repeats one or more of the steps described herein. In some aspects, the first network entity and/or the second network entity 1800 may receive the control signal from a scheduling entity. The transmitting circuitry 1846, shown and described above in connection with FIG. 18 may provide a means to transmit the one or more CSF parameters to the first network entity.

In one configuration, the second network entity 1800 includes means for performing the various functions and processes described in relation to FIG. 20. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-5, 9, 10A, 10B, 10C, 11, 12, and 18 and utilizing, for example, the processes and/or algorithms described herein in relation to FIG. 20.

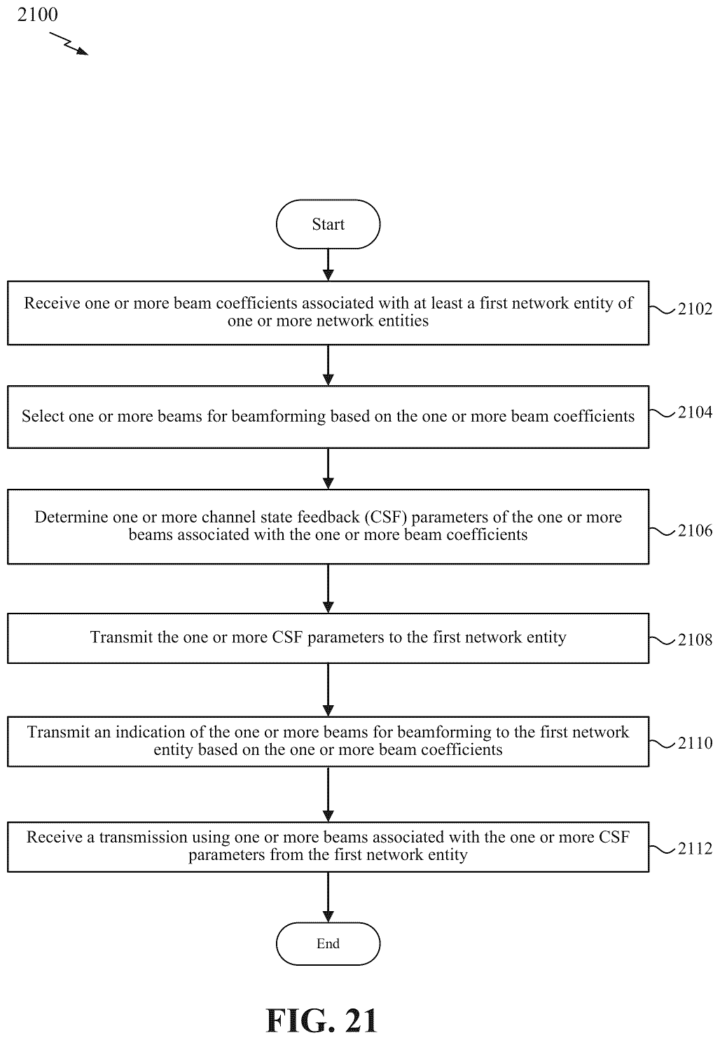

FIG. 21 is a flow chart 2100 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the second network entity 1800, as described herein, and illustrated in FIG. 18, by a processor or processing system, or by any suitable means for carrying out the described functions.

At block 2102, the second network entity 1800 may receive one or more beam coefficients associated with at least a first network entity of one or more network entities. Block 2102 includes the same or similar features described herein at least with respect to block 1902. At block 2104, the second network entity 1800 may select one or more beam s for beamforming based on the one or more beam coefficients. Block 2104 includes the same or similar features described herein at least with respect to block 1904. At block 2106, the second network entity 1800 may determine one or more channel state feedback (CSF) parameters of the one or more beams associated with the one or more beam coefficients. Block 2106 includes the same or similar features described herein at least with respect to block 2006. At block 2108, the second network entity 1800 may transmit the one or more CSF parameters to the first network entity. Block 2108 includes the same or similar features described herein at least with respect to block 2008.

At block 2110, the second network entity 1800 may transmit an indication of the one or more beams for beamforming to the first network entity based on the one or more beam coefficients. The transmitting circuitry 1846, shown and described above in connection with FIG. 18 may provide a means to transmit an indication of the one or more beams for beamforming to the first network entity based on the one or more beam coefficients.

At block 2112, the second network entity 1800 may receiving a transmission using one or more beams associated with the one or more CSF parameters from the first network entity. In some aspects, the first network entity may transmit (or send) a transmission using one or more beams associated with at least the one or more new beam coefficients to at least the second network entity 1800. For example, the first network entity may determine based on at least one of the one or more beam coefficients or the one or more new beam coefficients which one or more associated beams are the best one or more beams for beamforming. A best beam may be a beam with one or more high (e.g., highest) or optimal CSF parameters. For example, a best beam may have one or more of an optimal PMI, an optimal CQI, a high or highest RI, a high or highest RSRP, or the like. The first network entity may transmit a transmission using a best one or more beams of the one or more beams to at least the second network entity 1800.

In some aspects, one or more additional network entities, including a third network entity, may perform the same or similar operations as the second network entity 1800. For example, the third network entity may also transmit one or more CSF parameters of one or more beams associated with the third network entity to the first network entity. The first network entity may select one or more new beam coefficients based on at least the one or more CSF parameters received from the second network entity 1800 and the one or more CSF parameters received from the third network entity. In some aspects, the first network entity, the second network entity 1800, and the third network entity may store the CSF parameters and/or the beam coefficients for quick reporting and computation to one or more UEs at a future time and across different iterations. The first network entity may also select one or more new ports for beamforming based on the one or more new beam coefficients. Subsequently, the first network entity may transmit (or send) a transmission using one or more beams associated with at least the one or more new beam coefficients to at least the second network entity and the third network entity. For example, the first network entity may determine that a first beam associated with the second network entity 1800 is a best beam and a second beam associated with the third network entity is another best beam. The first network entity may transmit a transmission to the second network entity 1800 through the first beam and to the third network entity through the second beam. In this way, the second network entity 1800 and the third network entity may be a virtual super-node for beamforming with the first network entity. The receiving circuitry 1840 together with the transceiver 1810, shown and described above in connection with FIG. 18 may provide a means to receive a transmission using one or more beams associated with the one or more CSF parameters from the first network entity.

In one configuration, the second network entity 1800 includes means for performing the various functions and processes described in relation to FIG. 21. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-5, 9, 10A, 10B, 10C, 11, 12, and 18 and utilizing, for example, the processes and/or algorithms described herein in relation to FIG. 21.

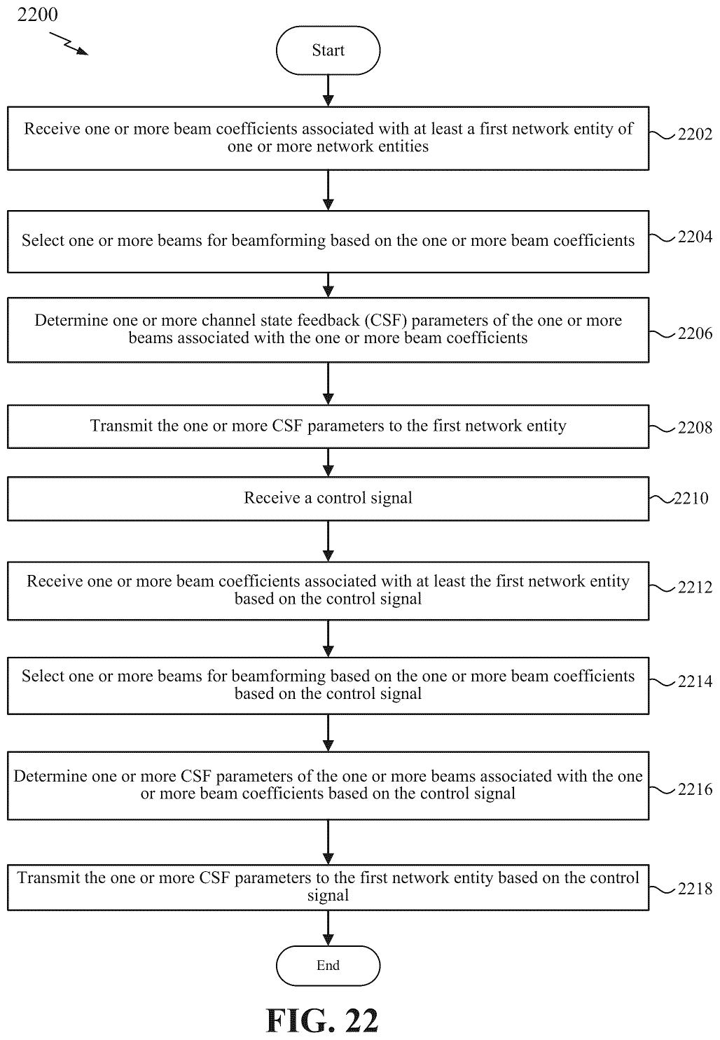

FIG. 22 is a flow chart 2200 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the second network entity 1800, as described herein, and illustrated in FIG. 18, by a processor or processing system, or by any suitable means for carrying out the described functions.

At block 2202, the second network entity 1800 may receive one or more beam coefficients associated with at least a first network entity of one or more network entities. Block 2202 includes the same or similar features described herein at least with respect to block 1902. At block 2204, the second network entity 1800 may select one or more beam s for beamforming based on the one or more beam coefficients. Block 2204 includes the same or similar features described herein at least with respect to block 1904. At block 2206, the second network entity 1800 may determine one or more channel state feedback (CSF) parameters of the one or more beams associated with the one or more beam coefficients. Block 2206 includes the same or similar features described herein at least with respect to block 2006. At block 2208, the second network entity 1800 may transmit the one or more CSF parameters to the first network entity. Block 2208 includes the same or similar features described herein at least with respect to block 2008.

At block 2210, the second network entity 1800 may receive a control signal. In some aspects, the second network entity 1800 may receive a control signal via at least one of radio resource control (RRC) signaling, medium access control (MAC) control element (MAC-CE) signal, sidelink control information (SCI), or downlink control information (DCI). In some aspects, after transmitting the one or more beam coefficients to at least the second network entity 1800, at least one of the first network entity or the second network entity 1800 may repeat one or more the steps described herein based on the received control signal. For example, first network entity may repeat the steps of determining one or more channel state feedback (CSF) parameters of one or more beams associated with the first network entity, selecting one or more beam coefficients based on the one or more CSF parameters, and transmitting the one or more beam coefficients to at least the second network entity 1800. As another example, the second network entity 1800 may repeat the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, and transmitting the one or more CSF parameters to the first network entity. In some aspects, in addition to or as alternative to indicating a number of times that the first network entity and/or the second network entity 1800 repeats the one or more steps described herein, the control signal may indicate which one or more steps described herein are to be repeated. The receiving circuitry 1840, shown and described above in connection with FIG. 18 may provide a means to receive a control signal.

In some aspects, the first network entity may be a receiving UE and the second network entity 1800 may be transmitting UE such that the second network entity 1800 may subsequently send a transmission to the first network entity based on a selection of the best beams determined by the first network entity and/or the second network entity 1800. The best beams may be the beams with the highest performance, such as the highest modulation and coding scheme (MCS) values, signal to noise ratio (SINR) values, or the like. As described herein, these steps may be repeated multiple time amongst the first network entity and/or the second network entity 1800 in order to continuously determine the best beams between the first network entity and/or the second network entity 1800 and create a super node for beamforming. In some aspects, these steps may be expanded to a plurality of network entities and repeated one or more times in order to continuously determine the best beams between the plurality of network entity and create super nodes amongst the plurality of network for beamforming and relaying. In some aspects, the shared indices or beam coefficients may each include an indication of the source (e.g., the first network entity) so that each of the plurality of network entities may associate a particular received indices or beam coefficient with a particular network entity of the plurality of network entities.

At block 2212, the second network entity 1800 may receive one or more beam coefficients associated with at least a first network entity of one or more network entities based on the control signal. Block 2212 includes the same or similar features described herein at least with respect to block 1902. At block 2214, the second network entity 1800 may select one or more beams for beamforming based on the one or more beam coefficients based on the control signal. Block 2214 includes the same or similar features described herein at least with respect to block 1904. At block 2216, the second network entity 1800 may determine one or more channel state feedback (CSF) parameters of the one or more beams associated with the one or more beam coefficients based on the control signal. Block 2216 includes the same or similar features described herein at least with respect to block 2006. At block 2218, the second network entity 1800 may transmit the one or more CSF parameters to the first network entity based on the control signal. Block 2218 includes the same or similar features described herein at least with respect to block 2008.

In one configuration, the second network entity 1800 includes means for performing the various functions and processes described in relation to FIG. 22. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-5, 9, 10A, 10B, 10C, 11, 12, and 18 and utilizing, for example, the processes and/or algorithms described herein in relation to FIG. 22.

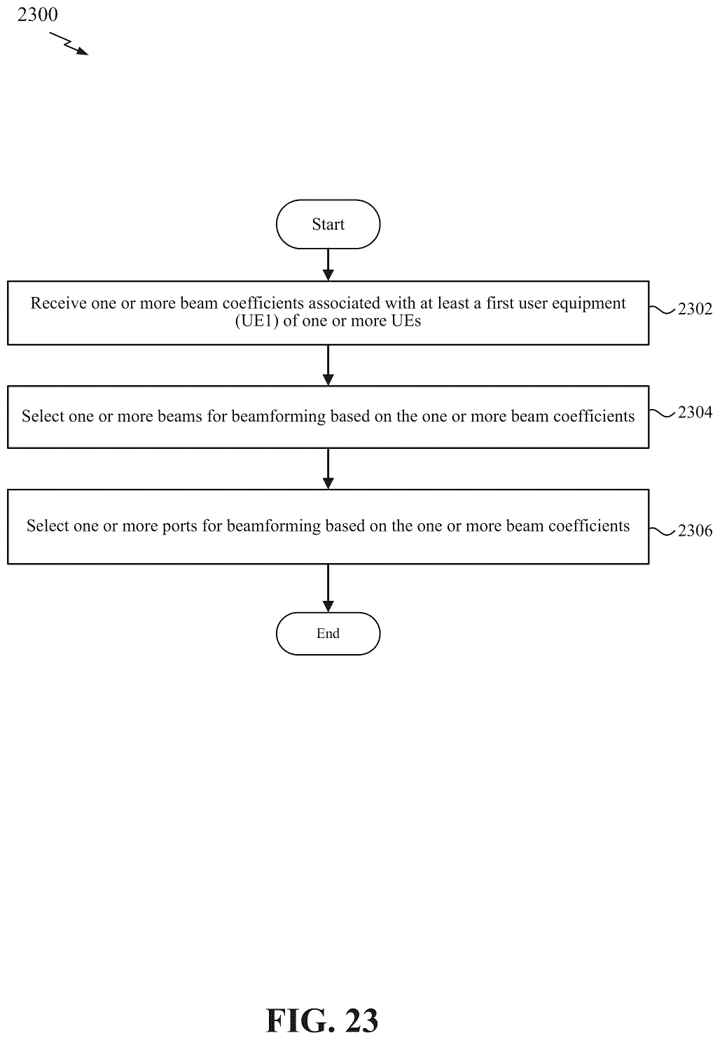

FIG. 23 is a flow chart 2300 of a method for iterative precoders computation and coordination according to some aspects. As described below, some or all illustrated features may be omitted in a particular implementation within the scope of the present disclosure, and some illustrated features may not be required for implementation of all aspects. In some examples, the method may be performed by the second network entity 1800, as described herein, and illustrated in FIG. 18, by a processor or processing system, or by any suitable means for carrying out the described functions.

At block 2302, the second network entity 1800 may receive one or more beam coefficients associated with at least a first network entity of one or more network entities. Block 2302 includes the same or similar features described herein at least with respect to block 1902. At block 2304, the second network entity 1800 may select one or more beam s for beamforming based on the one or more beam coefficients. Block 2304 includes the same or similar features described herein at least with respect to block 1904.

At block 2306, the second network entity 1800 may select one or more ports for beamforming based on the one or more beam coefficients. In some aspects, port selection may use precoded CSI-RS with known underlying beams and coefficients. The selecting circuitry 1842, shown and described above in connection with FIG. 18 may provide a means to select one or more ports for beamforming based on the one or more beam coefficients.

In one configuration, the second network entity 1800 includes means for performing the various functions and processes described in relation to FIG. 23. In one aspect, the aforementioned means may be the processor 1804 shown in FIG. 18 configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-5, 9, 10A, 10B, 10C, 11, 12, and 18 and utilizing, for example, the processes and/or algorithms described herein in relation to FIG. 23.

In a first aspect, a first network entity (e.g., a first UE) in a wireless communication system may determine one or more channel state feedback (CSF) parameters of one or more beams associated with the first network entity. The first network entity may also select one or more beam coefficients based on the one or more CSF parameters. The first network entity may further transmit the one or more beam coefficients to at least a second network entity. In addition, the first network entity may receive one or more additional CSF parameters from the second network entity in response to transmitting the one or more beam coefficients to at least the second network entity. The first network entity may also select one or more new beam coefficients based on at least the one or more additional CSF parameters. The first network entity may further send a transmission using one or more beams associated with at least the one or more new beam coefficients to at least the second network entity.

In a second aspect, alone or in combination with the first aspect, the first network entity may also select one or more ports for beamforming based on the one or more beam coefficients.

In a third aspect, alone or in combination with one or more of the first and second aspects, the first network entity selecting the one or more beam coefficients based on the one or more CSF parameters may include selecting one or more precoders associated with the one or more beam coefficients based on the one or more CSF parameters.

In a fourth aspect, alone or in combination with one or more of the first through third aspects, the first network entity may also select the one or more new beam coefficients based on the one or more CSF parameters.

In a fifth aspect, alone or in combination with one or more of the first through fourth aspects, the first network entity may select one or more new ports for beamforming based on the one or more new beam coefficients.

In a sixth aspect, alone or in combination with one or more of the first through fifth aspects, the one or more additional CSF parameters may include at least one of one or more transmission configuration indicators (TCI) state or one or more analog beamformers.

In a seventh aspect, alone or in combination with one or more of the first through sixth aspects, the one or more CSF parameters may be codebook based and include a report that includes at least one of precoding matrix indicator (PMI), channel quality information (CQI), rank indication (RI), reference signal received power (RSRP), or an indication of at least one wideband (WB) beam.

In an eighth aspect, alone or in combination with one or more of the first through seventh aspects, the one or more CSF parameters may include one or more quantized versions of beams.

In a ninth aspect, alone or in combination with one or more of the first through eighth aspects, the first network entity may be capable of determining CSF parameters at a quicker rate compared to the second network entity.

In a tenth aspect, alone or in combination with one or more of the first through ninth aspects, the first network entity may also receive a control signal via at least one of radio resource control (RRC) signaling, medium access control (MAC) control element (MAC-CE) signal, sidelink control information (SCI), or downlink control information (DCI), and, after transmitting the one or more beam coefficients to at least the second network entity, repeat, based on the control signal the steps of determining one or more channel state feedback (CSF) parameters of one or more beams associated with the first network entity, selecting one or more beam coefficients based on the one or more CSF parameters, transmitting the one or more beam coefficients to at least the second network entity, receiving one or more additional CSF parameters from the second network entity in response to transmitting the one or more beam coefficients to at least the second network entity, selecting one or more new beam coefficients based on at least the one or more additional CSF parameters, and sending a transmission using one or more beams associated with at least the one or more new beam coefficients to at least the second network entity.

In an eleventh aspect, alone or in combination with one or more of the first through tenth aspects, the first network entity may also store the selected one or more beam coefficients, and transmit the one or more beam coefficients to at least a third network entity after transmitting the one or more beam coefficients to at least the second network entity.

In a twelfth aspect, alone or in combination with one or more of the first through eleventh aspects, the first network entity transmitting the one or more beam coefficients to at least the second network entity may include transmitting an identity of the first network entity.

In a thirteenth aspect, alone or in combination with one or more of the first through twelfth aspects, the first network entity transmitting the one or more beam coefficients to at least the second network entity may include transmitting average covariance matrices of one or more channels.

In a fourteenth aspect, a second network entity (e.g., a second UE) in a wireless communication system may receive one or more beam coefficients associated with at least a first network entity of one or more network entities. The second network entity may also select one or more beams for beamforming based on the one or more beam coefficients. The second network entity may further determine one or more channel state feedback (CSF) parameters of the one or more beams associated with the one or more beam coefficients. In addition, the second network entity may transmit the one or more CSF parameters to the first network entity. The second network entity may also receive a transmission using one or more beams associated with the one or more CSF parameters from the first network entity.

In a fifteenth aspect, alone or in combination with the fourteenth aspect, the second network entity may also determine one or more channel state feedback (CSF) parameters of the one or more beams associated with the one or more beam coefficients, and transmit the one or more CSF parameters to the first network entity.

In a sixteenth aspect, alone or in combination with one or more of the fourteenth through fifteenth aspects, the second network entity receiving the one or more beam coefficients associated with the first network entity may include receiving one or more precoders associated with the one or more beam coefficients.

In a seventeenth aspect, alone or in combination with one or more of the fourteenth through sixteenth aspects, the second network entity may also receive a control signal via at least one of radio resource control (RRC) signaling, medium access control (MAC) control element (MAC-CE) signal, sidelink control information (SCI), or downlink control information (DCI), and, after transmitting the one or more CSF parameters to the first network entity, repeat, based on the control signal the steps of receiving one or more beam coefficients associated with at least the first network entity of the one or more network entities, selecting one or more beams for beamforming based on the one or more beam coefficients, determining one or more channel state feedback (CSF) parameters of one or more beams associated with the one or more beam coefficients, transmitting the one or more CSF parameters to the first network entity, and receiving a transmission using one or more beams associated with the one or more CSF parameters from the first network entity.

In an eighteenth aspect, alone or in combination with one or more of the fourteenth through seventeenth aspects, the second network entity may also select one or more ports for beamforming based on the one or more beam coefficients.

In a nineteenth aspect, alone or in combination with one or more of the fourteenth through eighteenth aspects, the one or more CSF parameters may include at least one of one or more transmission configuration indicators (TCI) state or one or more analog beamformers.

In a twentieth aspect, alone or in combination with one or more of the fourteenth through nineteenth aspects, the one or more CSF parameters may be codebook based and include a report that includes at least one of precoding matrix indicator (PMI), channel quality information (CQI), rank indication (RI), reference signal received power (RSRP), or an indication of at least one wideband (WB) beam.

In a twenty-first aspect, alone or in combination with one or more of the fourteenth through twentieth aspects, the one or more CSF parameters may include one or more quantized versions of beams.

In a twenty-second aspect, alone or in combination with one or more of the fourteenth through twenty-first aspect, the first network entity may be capable of determining CSF parameters at a quicker rate compared to the second network entity.

In a twenty-third aspect, alone or in combination with one or more of the fourteenth through twenty-second aspect, receiving the one or more beam coefficients from the first network entity may include receiving an identity of the first network entity.

In a twenty-fourth aspect, alone or in combination with one or more of the fourteenth through twenty-third aspect, receiving the one or more beam coefficients from the first network entity comprises receiving average covariance matrices of one or more channels.

In one configuration, a first network entity (e.g., a first UE) may include means for determining one or more channel state feedback (CSF) parameters of one or more beams associated with the first network entity, means for selecting one or more beam coefficients based on the one or more CSF parameters, means for transmitting the one or more beam coefficients to at least a second network entity, means for receiving one or more additional CSF parameters from the second network entity in response to transmitting the one or more beam coefficients to at least the second network entity, means for selecting one or more new beam coefficients based on at least the one or more additional CSF parameters, and means for sending a transmission using one or more beams associated with at least the one or more new beam coefficients to at least the second network entity.

In one aspect, the aforementioned means for determining one or more channel state feedback (CSF) parameters of one or more beams associated with the first network entity, means for selecting one or more beam coefficients based on the one or more CSF parameters, and means for transmitting the one or more beam coefficients to at least a second network entity may be the processor(s) 1204 shown in FIG. 12 configured to perform the functions recited by the aforementioned means. For example, the aforementioned means for determining one or more channel state feedback (CSF) parameters of one or more beams associated with the first network entity may include the determining circuitry 1240 shown in FIG. 12. As another example, the aforementioned means for selecting one or more beam coefficients based on the one or more CSF parameters may include the selecting circuitry 1242 shown in FIG. 12. As yet another example, the aforementioned means for transmitting the one or more beam coefficients to at least a second network entity may include the transmitting circuitry 1244 and transceiver 1210 shown in FIG. 12. As yet another example, the aforementioned means for receiving one or more additional CSF parameters from the second network entity in response to transmitting the one or more beam coefficients to at least the second network entity may include the receiving circuitry 1246 and transceiver 1210 shown in FIG. 12. As yet another example, the aforementioned means for selecting one or more new beam coefficients based on at least the one or more additional CSF parameters may include the selecting circuitry 1242 shown in FIG. 12. As yet another example, the aforementioned means for sending or transmitting a transmission using one or more beams associated with at least the one or more new beam coefficients to at least the second network entity may include the transmitting circuitry 1244 and transceiver 1210 shown in FIG. 12. In another aspect, the aforementioned means may be a circuit or any apparatus configured to perform the functions recited by the aforementioned means.

In one configuration, a second network entity (e.g., a second UE) may include means for receiving one or more beam coefficients associated with at least a first network entity of one or more network entities, means for selecting one or more beams for beamforming based on the one or more beam coefficients, means for determining one or more channel state feedback (CSF) parameters of the one or more beams associated with the one or more beam coefficients, means for transmitting the one or more CSF parameters to the first network entity, and means for receiving a transmission using one or more beams associated with the one or more CSF parameters from the first network entity.

In one aspect, the aforementioned means for receiving one or more beam coefficients associated with at least a first network entity of one or more network entities, and means for selecting one or more beams for beamforming based on the one or more beam coefficients may be the processor(s) 1804 shown in FIG. 18 configured to perform the functions recited by the aforementioned means. For example, the aforementioned means for receiving one or more beam coefficients associated with at least a first network entity of one or more network entities may include the receiving circuitry 1840 and transceiver 1810 shown in FIG. 18. As another example, the aforementioned means for selecting one or more beams for beamforming based on the one or more beam coefficients may include the selecting circuitry 1842 shown in FIG. 18. As yet another example, the aforementioned means for determining one or more channel state feedback (CSF) parameters of the one or more beams associated with the one or more beam coefficients may include the determining circuitry 1844 shown in FIG. 18. As yet another example, the aforementioned means for transmitting the one or more CSF parameters to the first network entity may include the transmitting circuitry 1846 together with the transceiver 1810 shown in FIG. 18. As yet another example, the aforementioned means for receiving a transmission using one or more beams associated with the one or more CSF parameters from the first network entity may include the receiving circuitry 1840 together with the transceiver 1810 shown in FIG. 18. In another aspect, the aforementioned means may be a circuit or any apparatus configured to perform the functions recited by the aforementioned means.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-23 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5, 9, 10A, 10B, 10C, 11, 12, and 18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for wireless communication by a first network entity, comprising:
determining one or more channel state feedback (CSF) parameters of one or more beams associated with the first network entity;
selecting one or more beam coefficients based on the one or more CSF parameters;
transmitting the one or more beam coefficients to at least a second network entity;
receiving one or more additional CSF parameters from the second network entity in response to transmitting the one or more beam coefficients to at least the second network entity;
selecting one or more new beam coefficients based on at least the one or more additional CSF parameters; and
sending a transmission using one or more beams associated with at least the one or more new beam coefficients to at least the second network entity.

2. The method of claim 1, further comprising:
selecting one or more ports for beamforming based on the one or more beam coefficients.

3. The method of claim 1, wherein selecting the one or more beam coefficients based on the one or more CSF parameters comprises selecting one or more precoders associated with the one or more beam coefficients based on the one or more CSF parameters.

4. The method of claim 1, wherein selecting the one or more new beam coefficients is also based on the one or more CSF parameters.

5. The method of claim 1, further comprising:
selecting one or more new ports for beamforming based on the one or more new beam coefficients.

6. The method of claim 1, wherein the one or more additional CSF parameters comprise at least one of one or more transmission configuration indicators (TCI) state or one or more analog beamformers.

7. The method of claim 1, wherein the one or more CSF parameters are codebook based and include a report that includes at least one of precoding matrix indicator (PMI), channel quality information (CQI), rank indication (RI), reference signal received power (RSRP), or an indication of at least one wideband (WB) beam.

8. The method of claim 1, further comprising:
receiving a control signal via at least one of radio resource control (RRC) signaling, medium access control (MAC) control element (MAC-CE) signal, sidelink control information (SCI), or downlink control information (DCI); and
after sending the one or more beam coefficients to at least the second network entity, repeating, based on the control signal:
determining one or more channel state feedback (CSF) parameters of one or more beams associated with the first network entity,
selecting one or more beam coefficients based on the one or more CSF parameters,
transmitting the one or more beam coefficients to at least the second network entity,
receive one or more additional CSF parameters from the second network entity in response to transmitting the one or more beam coefficients to at least the second network entity,
select one or more new beam coefficients based on at least the one or more additional CSF parameters, and
send a transmission using one or more beams associated with at least the one or more new beam coefficients to at least the second network entity.

9. The method of claim 1, wherein transmitting the one or more beam coefficients to at least the second network entity comprises transmitting average covariance matrices of one or more channels.

10. A method for wireless communication by a second network entity, comprising:
receiving one or more beam coefficients associated with at least a first network entity of one or more network entities;
selecting one or more beams for beamforming based on the one or more beam coefficients;
determining one or more channel state feedback (CSF) parameters of the one or more beams associated with the one or more beam coefficients;
transmitting the one or more CSF parameters to the first network entity; and
receiving a transmission using one or more beams associated with the one or more CSF parameters from the first network entity.

11. The method of claim 10, wherein receiving the one or more beam coefficients associated with the first network entity comprises receiving one or more precoders associated with the one or more beam coefficients.

12. The method of claim 10, further comprising:
receiving a control signal via at least one of radio resource control (RRC) signaling, medium access control (MAC) control element (MAC-CE) signal, sidelink control information (SCI), or downlink control information (DCI); and
after receiving the transmission using one or more beams associated with the one or more CSF parameters from the first network entity, repeating, based on the control signal:
receiving one or more beam coefficients associated with at least the first network entity of the one or more network entities,
selecting one or more beams for beamforming based on the one or more beam coefficients,
determining one or more channel state feedback (CSF) parameters of one or more beams associated with the one or more beam coefficients,
transmitting the one or more CSF parameters to the first network entity, and
receiving a transmission using one or more beams associated with the one or more CSF parameters from the first network entity.

13. The method of claim 10, wherein the one or more CSF parameters comprise at least one of one or more transmission configuration indicators (TCI) state or one or more analog beamformers.

14. The method of claim 10, wherein the one or more CSF parameters are codebook based and include a report that includes at least one of precoding matrix indicator (PMI), channel quality information (CQI), rank indication (RI), reference signal received power (RSRP), or an indication of at least one wideband (WB) beam.

15. The method of claim 10, wherein receiving the one or more beam coefficients from the first network entity comprises receiving average covariance matrices of one or more channels.

16. A first network entity for wireless communication in a wireless communication network, comprising:
a wireless transceiver;
a memory; and
a processor communicatively coupled to the wireless transceiver and the memory, wherein the processor and the memory are configured to:
determine one or more channel state feedback (CSF) parameters of one or more beams associated with the first network entity,
select one or more beam coefficients based on the one or more CSF parameters,
transmit the one or more beam coefficients to at least a second network entity,
receive one or more additional CSF parameters from the second network entity in response to transmitting the one or more beam coefficients to at least the second network entity,
select one or more new beam coefficients based on at least the one or more additional CSF parameters, and
send a transmission using one or more beams associated with at least the one or more new beam coefficients to at least the second network entity.

17. The first network entity of claim 16, wherein the processor and the memory are further configured to:
select one or more ports for beamforming based on the one or more beam coefficients.

18. The first network entity of claim 16, wherein selecting the one or more beam coefficients based on the one or more CSF parameters comprises selecting one or more precoders associated with the one or more beam coefficients based on the one or more CSF parameters.

19. The first network entity of claim 16, wherein selecting the one or more new beam coefficients is also based on the one or more CSF parameters.

20. The first network entity of claim 16, wherein the processor and the memory are further configured to:
select one or more new ports for beamforming based on the one or more new beam coefficients.

21. The first network entity of claim 16, wherein the one or more additional CSF parameters comprise at least one of one or more transmission configuration indicators (TCI) state or one or more analog beamformers.

22. The first network entity of claim 16, wherein the one or more CSF parameters are codebook based and include a report that includes at least one of precoding matrix indicator (PMI), channel quality information (CQI), rank indication (RI), reference signal received power (RSRP), or an indication of at least one wideband (WB) beam.

23. The first network entity of claim 16, wherein the processor and the memory are further configured to:
receive a control signal via at least one of radio resource control (RRC) signaling, medium access control (MAC) control element (MAC-CE) signal, sidelink control information (SCI), or downlink control information (DCI); and
after transmitting the one or more beam coefficients to at least the second network entity, repeat, based on the control signal:
determining one or more channel state feedback (CSF) parameters of one or more beams associated with the first network entity,
selecting one or more beam coefficients based on the one or more CSF parameters,
transmitting the one or more beam coefficients to at least the second network entity,
receiving one or more additional CSF parameters from the second network entity in response to transmitting the one or more beam coefficients to at least the second network entity,
selecting one or more new beam coefficients based on at least the one or more additional CSF parameters, and
sending a transmission using one or more beams associated with at least the one or more new beam coefficients to at least the second network entity.

24. The first network entity of claim 16, wherein transmitting the one or more beam coefficients to at least the second network entity comprises transmitting average covariance matrices of one or more channels.

25. A second network entity for wireless communication in a wireless communication network, comprising:
a wireless transceiver;
a memory; and
a processor communicatively coupled to the wireless transceiver and the memory, wherein the processor and the memory are configured to:
receive one or more beam coefficients associated with at least a first network entity of one or more network entities,
select one or more beams for beamforming based on the one or more beam coefficients,
determine one or more channel state feedback (CSF) parameters of the one or more beams associated with the one or more beam coefficients,
transmit the one or more CSF parameters to the first network entity, and
receive a transmission using one or more beams associated with the one or more CSF parameters from the first network entity.

26. The second network entity of claim 25, wherein receiving the one or more beam coefficients associated with the first network entity comprises receiving one or more precoders associated with the one or more beam coefficients.

27. The second network entity of claim 26, wherein the processor and the memory are further configured to:
receive a control signal via at least one of radio resource control (RRC) signaling, medium access control (MAC) control element (MAC-CE) signal, sidelink control information (SCI), or downlink control information (DCI); and
after transmitting the one or more CSF parameters to the first network entity, repeat, based on the control signal:
receiving one or more beam coefficients associated with at least the first network entity of the one or more network entities,
selecting one or more beams for beamforming based on the one or more beam coefficients,
determining one or more channel state feedback (CS F) parameters of the one or more beams associated with the one or more beam coefficients,
transmitting the one or more CSF parameters to the first network entity, and
receiving a transmission using one or more beams associated with the one or more CSF parameters from the first network entity.

28. The second network entity of claim 25, wherein the one or more CSF parameters comprise at least one of one or more transmission configuration indicators (TCI) state or one or more analog beamformers.

29. The second network entity of claim 25, wherein the one or more CSF parameters are codebook based and include a report that includes at least one of precoding matrix indicator (PMI), channel quality information (CQI), rank indication (RI), reference signal received power (RSRP), or an indication of at least one wideband (WB) beam.

30. The second network entity of claim 25, wherein receiving the one or more beam coefficients from the first network entity comprises receiving average covariance matrices of one or more channels.
